(19) United States
(12) Patent Application Publication
(10) Pub. No.: US 2010/0250461 A1
(43) Pub. Date: Sep. 30, 2010

(54) SYSTEM AND METHODS FOR TRANSPORTATION UTILIZATION AND CONTROL

(75) Inventors: William Craig Arnold, Parkersburg, WV (US); Earnest Lee Broyles, Parkersburg, WV (US); James Conard Richardson, Waverly, WV (US)

Correspondence Address: CAHN & SAMUELS LLP, 1100 17th STREET NW, SUITE 401, WASHINGTON, DC, 20036, US

(73) Assignee: GREENPAK DEVELOPMENT, INC., Parkersburg, WV (US)

(21) Appl. No.: 12/748,482

(22) Filed: Mar. 29, 2010

Related U.S. Application Data
(63) Continuation-in-part of application No. 11/314,193, filed on Dec. 22, 2005, now abandoned.
(60) Provisional application No. 61/167,622, filed on Apr. 8, 2009.

(51) Int. Cl. G06Q 10/00; G01S 19/42; G06K 7/10

(52) U.S. Cl. 705/333; 705/1.1; 342/357.25

(57) ABSTRACT

A complete logistics and transportation management system, with a number of integrated software and hardware components integrated to provide a total system for scheduling transportation assets. A method for tracking an asset includes adding at least one asset to a computer system having a web-accessible graphical user interface; adding properties to the asset in the computer system via at least one of a mobile or handheld computer or the graphical user interface; and displaying a searchable asset list in the graphical user interface, along with the quantity of each asset, location of each asset, and at least one picture of each asset.

### CROSS REFERENCE TO RELATED APPLICATIONS

This application is a Continuation-In-Part Application of U.S. Ser. No. 11/314,193 filed on Dec. 22, 2005 and claims benefit of Provisional Application Ser. No. 61/167,622 on Apr. 8, 2009, the entire contents of both applications are incorporated herein by reference.

### FIELD OF THE INVENTION

This invention relates generally to a system and method for the efficient warehousing, pickup, shipment and delivery of goods. More particularly, the invention relates to a system in which goods are tracked throughout an entire cycle of product creation and delivery and the system includes the generation of efficient shipment scheduling and routing protocols utilizing both inside and outside shippers and further includes efficient return and reuse of product shipping containers and/or support equipment.

### BACKGROUND OF THE INVENTION

Tracking of containers in transit is well developed, including the use of satellites and other electronic technology to obtain real-time data on in transit locations. Inventory accounting and management is also a well developed field in which the contents of very large warehouses are ascertainable with a high degree of detail at any point in time. An area which has been somewhat neglected, however, is the area of efficient scheduling and routing of deliverable products and their associated containers or support equipment.

Another critical area which is not addressed at all by most logistics systems is that of racks which support product within a container. In many respects, these racks, their location, expected time of arrival on return, and condition, are just as critical and valuable as the products they carry. For without racks, many products cannot be shipped. There is thus a need to track shipping racks, particularly on the return trip to suppliers, as closely as the shipment of product.

### SUMMARY OF THE INVENTION

Illustrative, non-limiting embodiments of the present invention overcome the aforementioned and other disadvantages associated with related art shipping and tracking systems.

It is an aspect of the present invention to provide a complete logistics and transportation management system, with a number of integrated software and hardware components integrated to provide a total system for scheduling transportation assets and all deliveries of outbound products, and all inbound returns of products for repair and remediation.

More particularly, an inventory scheduling and tracking system in accordance with the present invention is used to monitor, track and report on any number of processes, including manufacturing, repairs, quality control, testing, and storage. The system according to the invention is also very flexible in that it is very easily customizable to capture information or track processes of many different types.

Mobile data collection units are used as automatic near real-time windows into the system. The data collection units have a built-in imaging engine and bar codes of both one and two dimensions can be read at any time with respect to goods within the system. Information may also be manually entered using an alpha-numeric keyboard, on-screen letter recognition tools or screen keyboard, for example, Windows Mobile compatible handhelds, or via direct entry through a rugged touch screen.

Further, information collected on the mobile data collection units is transmitted, for example via 802.11 b wireless LAN, to an SQL Server back office operation. Data is instantly available for near real-time tracking of processes and inventory and for reporting via a desktop computer application or a website interface layer.

One exemplary embodiment of an inventory tracking system in accordance with the present invention tracks the receipt, assessment, repair, storage and shipment of metal containers in a manufacturing plant. In accordance with this embodiment, a secure web-accessible container search/repair approval tool is available to a customer.

With an SQL Server backend, personnel can run a customized desktop computer application, which provides an interface for scheduling loads, building optimized shipments from multiple loads, and cataloging returned goods.

Another particular exemplary embodiment in accordance with the present invention is a method for shipping and tracking goods that comprises loading input data into a system computer, generating a load data packet based on the loaded input data and processing the load packet data in the system computer to generate a shipment data packet, wherein the processing of the load data packet comprises one or more of evaluation of historical pick-up data with respect to a customer, evaluation of a customer relationship, evaluation of a status of outbound shipments and evaluation of a status of inbound shipments.

Another exemplary embodiment is a method for tracking an asset comprising adding at least one asset to a computer system having a web-accessible graphical user interface; adding properties to the at least one asset in the computer system via a mobile or handheld computer; and displaying a searchable asset list in the graphical user interface, along with the quantity of each asset, location of each asset, properties of each asset, and at least one picture of each asset.

According to an exemplary embodiment of the present invention a method for tracking an asset includes using a plurality of assets to make a finished good; and tracing a history of at least one asset used to make the finished good.

As used herein “substantially”, “generally”, and other words of degree, are used as a relative modifier intended to indicate permissible variation from the characteristic so modified. It is not intended to be limited to the absolute value or characteristic which it modifies but rather approaching or approximating such a physical or functional characteristic.

### BRIEF DESCRIPTION OF THE DRAWINGS

The aspects of the present invention will become more readily apparent by describing in detail illustrative, non-limiting embodiments thereof with reference to the accompanying drawings, in which:

FIG. 1 is an overall block diagram of a system in accordance with the invention.

FIG. 2 is a block diagram of a loading portion of the overall system of FIG. 1, in accordance with the invention.

FIG. 3 is a block diagram of an en route portion of the overall system of FIG. 1, in accordance with the invention.

FIG. 4 is a block diagram of an unloading portion of the overall system of FIG. 1, in accordance with the invention.

FIG. 5 is a block diagram of a warehousing portion of the overall system of FIG. 1, in accordance with the invention.

FIG. 6 is a block diagram of a delivery and repair process for collected reusable shipping equipment in accordance with the invention.

FIG. 7 is a screenshot of a web interface login screen for a tracking system according to a specific embodiment of the invention.

FIG. 8 is a screenshot of a web interface main menu of a tracking system according to a specific embodiment of the invention.

FIG. 9 is a screenshot of an asset listing accessible from the main menu of FIG. 8.

FIG. 10 is a screenshot of Asset Information, its properties, and related tabs.

FIG. 11 is a screenshot of an Associations tab and shows a link to a primary asset.

FIG. 12 is a screenshot of a Components tab.

FIG. 13 is a screenshot of an Action/Labor tab.

FIG. 14 is a screenshot of a View Property History tab.

FIG. 15 is a screenshot of a Shipment History.

FIG. 16a is a screenshot of a Shipment History Map and FIG. 16b is a screenshot of a Shipment History Sensors.

FIG. 17 is a screenshot of an Active Sensor tab and sensor data in graphs.

FIG. 18 is a screenshot of a File Library tab.

FIG. 19 is a screenshot of a Parts Listing.

FIG. 20 is a screenshot of Part Information, its properties, and related tabs.

FIG. 21 is a screenshot of a Standard Components tab.

FIG. 22 is a screenshot of an Action/Labor Types tab.

FIG. 23 is a screenshot of a Production tab.

FIG. 24 is a screenshot of a Projects Attachment.

FIG. 25 is a screenshot of a Transportation Main menu.

FIG. 26 is a screenshot of an Initiate Load screen.

FIG. 27 is a screenshot of a Shipment Initiation screen.

FIG. 28 is a screenshot of an Item Number Lookup screen.

FIG. 29 is a screenshot of an Item Number Maintenance screen.

FIG. 30 is a screenshot of an Initiate Shipment—Load Search screen.

FIG. 31 is a screenshot of an Initiate Shipment—Load Detail screen.

FIG. 32 is a screenshot of an Initiate Shipment—Billing Information screen.

FIG. 33 is a screenshot of a Shipment Search screen.

FIG. 34 is a screenshot of a Transportation Dispatch Interface.

FIG. 35 is a screenshot of a Transportation Interface.

FIG. 36 is a screenshot of a Carrier details.

FIG. 37 is a screenshot of a Messaging Interface.

FIG. 38 is a screenshot of a Tracking Interface showing a route for a carrier.

FIG. 39 is a screenshot of a Mobile Interface Main menu.

FIG. 40 is a screenshot of a Receipt/Ship screen.

FIG. 41 is a screenshot of a Move screen.

FIG. 42 is a screenshot of a Status screen.

FIG. 43 is a screenshot of an Associate screen.

FIG. 44 is a screenshot of a Consume screen.

FIG. 45 is a flowchart showing a method according to a specific embodiment of the present invention.

FIG. 46 is a schematic diagram of the exemplary functionalities of the DOTS system.

Exemplary, non-limiting, embodiments of the present invention are discussed in detail below. While specific configurations are discussed to provide a clear understanding, it should be understood that the disclosed configurations are provided for illustration purposes only. A person skilled in the relevant art will recognize that other configurations may be used without departing from the spirit and scope of the invention.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

### DETAILED DESCRIPTION OF INVENTION

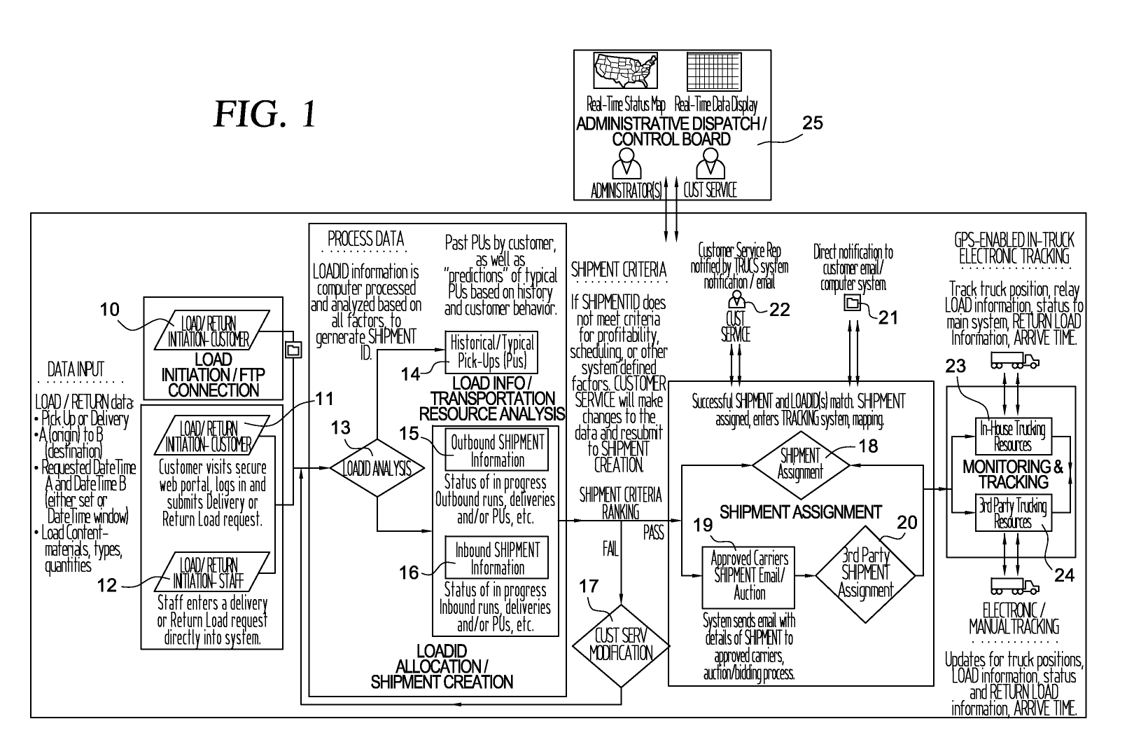

FIG. 1 is an overall block diagram of a transportation resource utilization and control system is accordance with the present invention. For example, the exemplary system illustrated in FIG. 1 may be utilized by a customer to order goods to be shipped from an original location to a final destination. The system can also be utilized to schedule, track and monitor the status of the shipment as well as schedule, track and monitor returned material, such as shipment containers for accepted goods and/or unaccepted goods.

As shown in FIG. 1, a customer initiates a delivery and/or return request by entering data either through an ftp (file transfer protocol) connection 10 or by accessing and logging into a secure website 11. Alternatively, if desired and when the situation warrants, an agent of the supplier initiates the delivery or return request by inputting data directly into the system 12.

The data entered into the system either by the customer or by the supplier's agent might include, for example, identification whether the event is a pick-up or a delivery, e.g., whether the customer has something for the supplier to pick-up at the customer's designated location, or whether the customer wishes the supplier to deliver a particular item to the customer's designated location. Other data entered into the system might include particular dates and times, or ranges of dates and times, the customer desires the pick-up or delivery to occur as well as identification of the specific item(s) desired for pick-up and/or delivery. The specific data mentioned here is exemplary only and a person of ordinary skill would understand that other specific data items could also be entered into the system at this time without departing from the spirit and scope of the invention.

After data such as that which was mentioned above has been entered into the system, a LOADID is created. A LOADID is a compilation of all data relevant to a corresponding shipment. The LOADID is then analyzed by being processed in a computer 13 to generate a SHIPMENTID. For example, in the generation of a SHIPMENTID, the delivery and/or return request data is processed in conjunction with historical data 14, outbound shipment data 15 and inbound shipment data 16. Historical data comprises, for example, data related to the customer's past pick-up orders as well as the customer's history and behavior. For instance, a particular customer might regularly order a pick-up or delivery on an urgent basis, that is, with a very short date and/or time requirement. However, if the customer “regularly” makes such orders, this information can be used in the analysis to plan for such a pick-up or delivery.

The SHIPMENTID includes an optimized schedule and route for a carrier to adopt in carrying out the respective pick-up and/or delivery. The SHIPMENTID is evaluated to determine whether or not the proposed schedule and route meet profitability criteria or other scheduling or system defined factors. If the proposed schedule or route does not meet, or “fails”, these criteria, the LOADID is modified, for example, by the intervention of a customer service representative 17, and the modified LOADID is presented again for LOADID processing by the system computer 13.

If the SHIPMENTID is analyzed and found to meet, or “pass”, the profitability, etc., criteria, the SHIPMENTID is provided to a shipment assignment process. In the shipment assignment process the specified shipment, i.e., the SHIPMENTID, is either assigned directly to a particular shipper 18, e.g., within the direct employ of the supplier, or the SHIPMENTID is passed along to one or more outside shippers approved by the supplier 19. The SHIPMENTID is provided to the approved outside shipper(s) by one or more of a variety of methods, for example, via e-mail or other Internet means, etc. In addition, if the SHIPMENTID is provided to more than one approved shipper, an auction or other type of bidding system may be utilized to determine which one of the approved shippers will ultimately be assigned the shipment. Once the particular approved carrier, i.e., third-party shipper, is selected for the shipment, the particular shipment (SHIPMENTID) is assigned to this carrier 20.

Subsequently, that is after the shipment (SHIPMENTID) has been completely assigned to a particular shipper, e.g., with a specified schedule and route, the customer is notified of the details of the assignment 21. For example, the customer is notified via the FTP interface, e-mail, etc. In particular, a match between the SHIPMENTID and a respective LOADID of a particular customer is sought. If a successful match is found, the SHIPMENTID is entered into the tracking system. In addition to the customer being notified, a customer service representative is also notified automatically via an electronic notification means, such as via e-mail 22.

Once the particular shipment has been assigned to a carrier, the shipment is forwarded to a monitoring and tracking system that monitors the status and location of the specific shipment from the point of origin to the destination point. For example, if the shipment is being shipped via an in-house truck 23, the location of the shipment is monitored via a GPS (global positioning satellite) system installed in the particular truck. If, on the other hand, the shipment is being shipped via a third-party shipper 24, the location of the shipment is tracked using periodic updates to an electronic database. For example, the particular trucker can manually enter location data into a handheld computing device which, in turn, uploads the data to the supplier's system. Alternatively, the third-party vehicle could also be equipped with a GPS system which could automatically update a database accessible by the supplier's system or provide the trucker with specific location data that the trucker can then manually enter into the system.

Regardless of whether the shipment is shipped via in-house resources 23 or third-party resources 24, however, the shipper provides additional data to location data in order to monitor the status, e.g., physical condition, of the shipment. For example, the electronic data sent from the shipper, e.g., truck, includes LOAD and/or RETURN LOAD information identifying the particular goods included in the shipment to the customer or returned goods being returned to the supplier, respectively. Further, the additional information provided includes an ARRIVE TIME which indicates the estimated time that the shipment will arrive at the final destination.

Also, it should be noted that all during the processes described above with respect to shipment initiation through shipment delivery, the data corresponding to the shipment can be monitored and/or modified via an administrative dispatch and control board 25. For instance, one or more shipments can be tracked and monitored in real-time by personnel, e.g., administrators or customer service representatives. Accordingly, if any problems occur with respect to any shipment, for example, a truck breaks down while enroute with a shipment, an alternative SHIPMENTID can be generated, or the original one modified, such that minimal time is lost due to the problem.

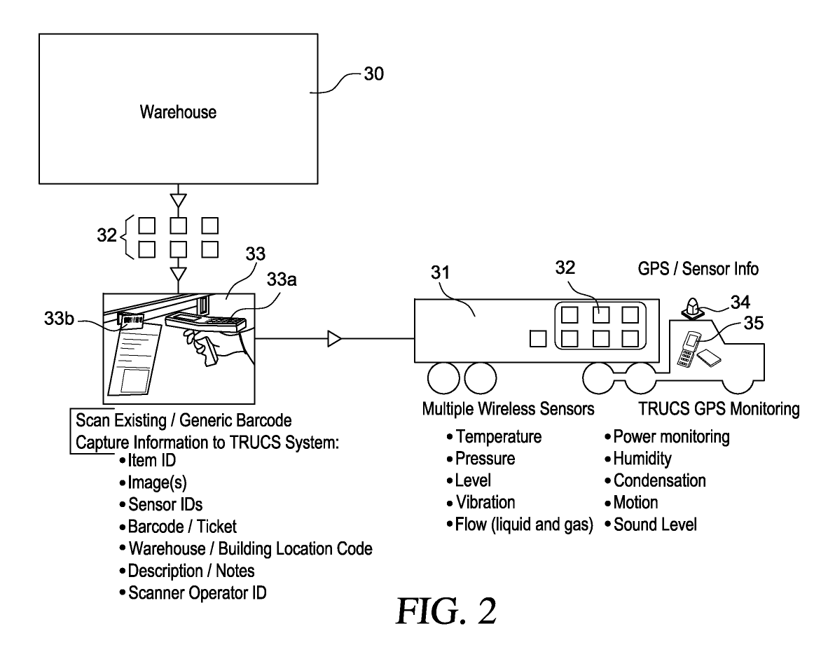

FIG. 2 illustrates an exemplary embodiment of the invention with respect to a loading process that occurs, for example, at the supplier warehouse. In particular, a warehouse 30 stores goods to be shipped pursuant to the shipping process disclosed above with respect to FIG. 1. After the load for the shipment is identified (LOADID), a shipment identification (SHIPMENTID) has been generated, and the shipment has been assigned to a particular carrier, for example an in-house truck 31 as shown in FIG. 2, the shipment 32 is removed from the warehouse 30 and scanned 33 using, for example, a handheld data collection device 33a. The handheld data collection device can be any suitable mobile unit, such as the Dolphin® 9500 barcode reader, manufactured by Hand Held™ Products, Inc. of Skaneateles Falls, N.Y.

According to one embodiment, data collection device 33a scans a barcode label 33b attached to each of one or more objects related to a particular shipment 32. By scanning the label particular details related to the shipment are automatically collected and either stored within the data collection device 33a and/or directly outputted, e.g., wirelessly, to a supervisory database (not shown). Further, the scanning of the label 33b can be performed via RF (radio frequency) technology by placing the data collection unit 33a in the proximity of the label 33b or the data can be collected by physically contacting the collection unit 33a to the label 33b.

Regardless of the particular mechanism by which the data is gathered, the data collected includes, for example, one or more of, an item identification; digital images of the goods themselves or portions of the goods; data from any specified sensors, such as, temperature sensors, vibration sensors, humidity sensors, etc.; a barcode ticket; a warehouse or building location code; a description of the goods and/or notes pertaining the goods or special instructions for handling, etc.; and a scanner and/or operator identification code.

After the shipment data is gathered by the data collection device 33, the shipment is loaded onto the truck 31, or other vehicle, such as a train, plane, boat, etc., for shipment to the specified destination. Within the truck 31 various sensors, such as one or more of temperature, pressure, level, vibration, flow, humidity, power monitoring, condensation, motion and sound level, sensors can be installed to continuously or on-demand, upload the sensor data via the GPS unit 34. The sensor data can be automatically uploaded from the sensors to the GPS unit or it can be scanned by a handheld device 35. The GPS device, in addition to uploading the sensor data also uploads location tracking data indicating the exact location of the truck, or other vehicle, as well as the shipment carried within.

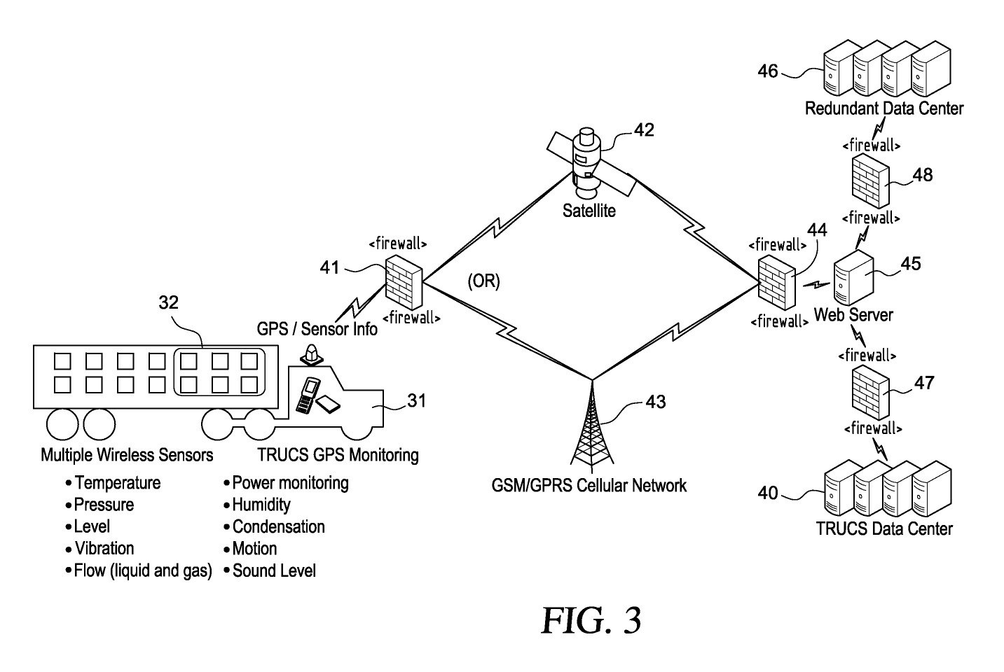

FIG. 3 illustrates an exemplary embodiment of the invention with respect to the actual shipping process as the truck, or other vehicle, is physically enroute from the origin location to the destination location. As shown, truck 31 with shipment 32 aboard uploads the data from the sensors, as discussed above with respect to FIG. 2, to a data center 40 in real-time. More particularly, while enroute, truck 31, using GPS unit 34, transmits sensor and location data through a first firewall 41 to either a satellite 42 or a GSM/GPRS cellular network 43. The data is transmitted from the satellite or GSM/GPRS cellular network 43 through another firewall 44 to a web server 45. Thereafter, the data is sent to the data center 40 and an optional redundant data center 46 through respective corresponding firewalls 47, 48.

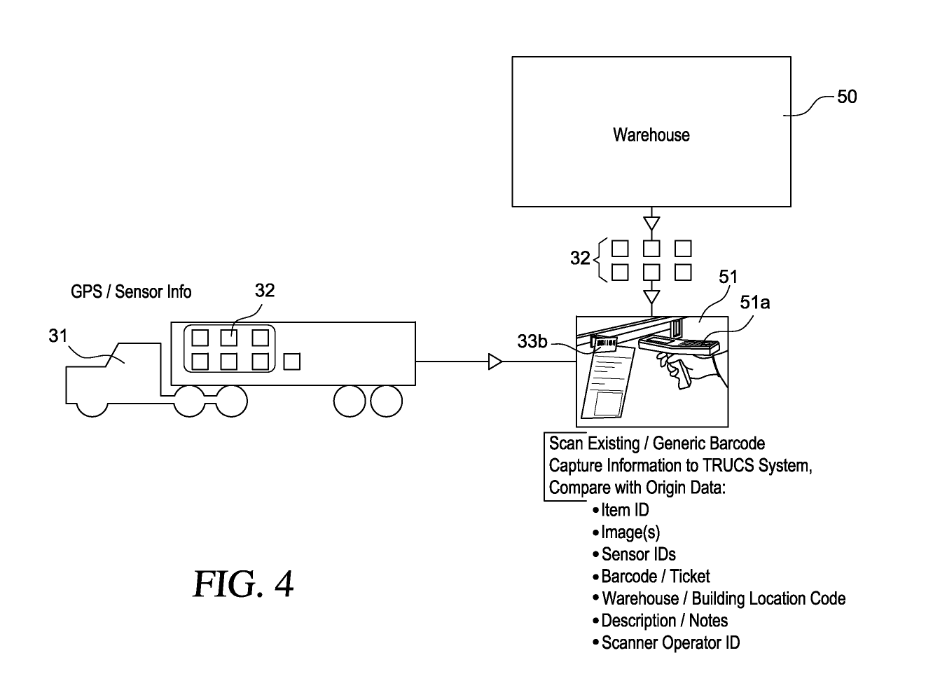

FIG. 4 illustrates an exemplary embodiment of the invention with respect to an unloading process that occurs, for example, at the customer warehouse. In particular, a warehouse 50 receives and stores goods shipped pursuant to the shipping process disclosed above with respect to FIGS. 1 and 2. Once the shipment has reached its final destination, e.g., on truck 31, the shipment 32 corresponding to the original LOADID is removed from the truck 31 and scanned 51 using, for example, a handheld data collection device 51a similar to the handheld device disclosed with respect to FIG. 2. The label 33b is scanned to ensure delivery of the specified shipment and to evaluate whether the shipment is in an acceptable condition as compared to the condition it was when it left the supplier's location.

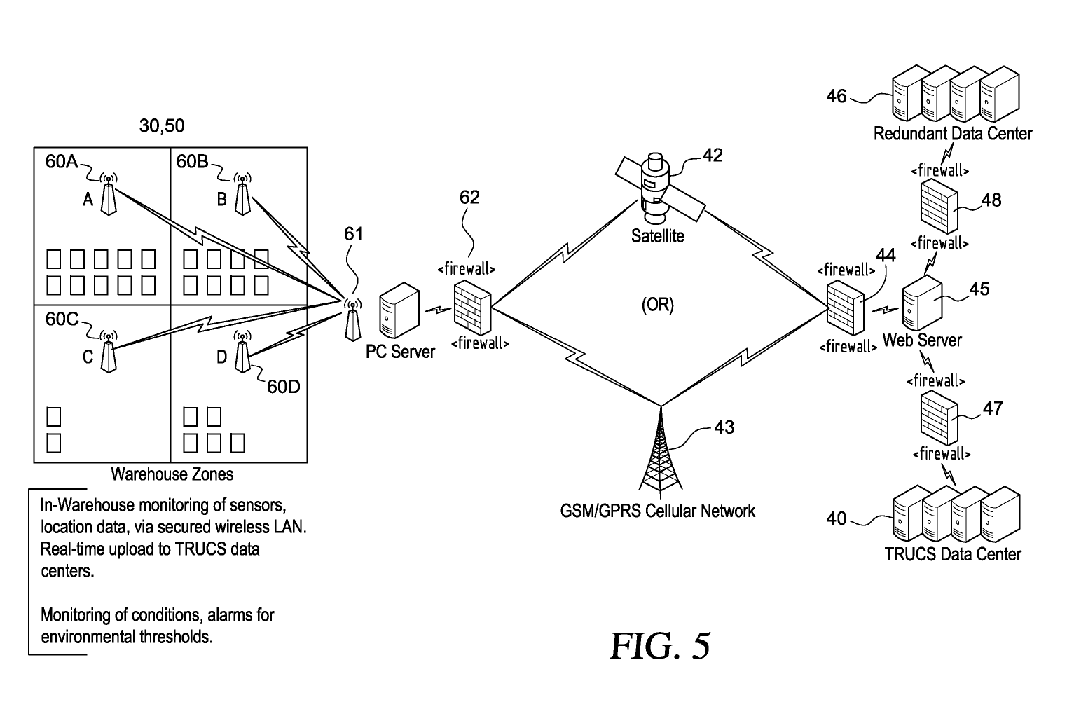

FIG. 5 illustrates an exemplary embodiment of the invention with respect to a warehouse storage process that occurs, for example, at either or both of the customer's or supplier's warehouses. In particular, FIG. 5 illustrates a data collection process that occurs while a warehouse 30, 50 stores goods or containers to be shipped or goods or containers that have already been shipped, pursuant to the shipping process disclosed above with respect to FIGS. 1 and 2. The warehouse is divided into warehouse zones (A-D) that each includes a wireless transponder 60A-60D. Wireless transponders 60A-60D each continuously monitor data received from the goods stored within their respective zone. For example, the goods stored can include or otherwise be associated with an RF tag that periodically transmits data to the wireless transponder. The wireless transponders then transmit the data to a PC server 61 that is connected to a receiver for receiving the data from the transponders. The PC server 61 then transmits the data corresponding to the stored goods through a firewall 62 and on to the data center 40 and redundant data center 46 in the same manner as data was sent to these data centers from the truck 31 with respect to FIG. 3.

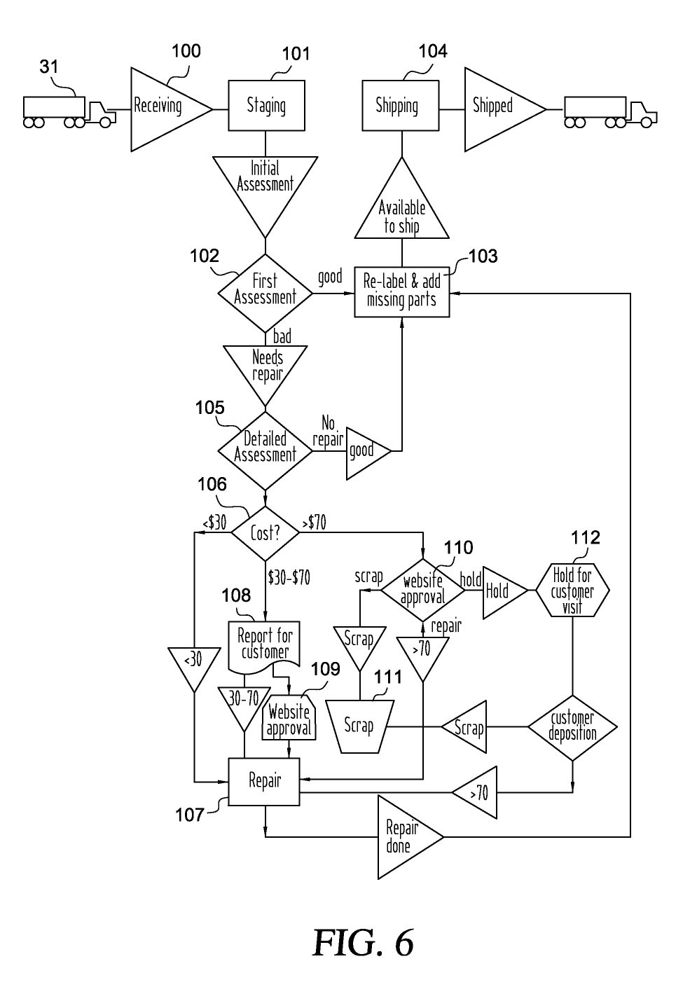

FIG. 6 illustrates an exemplary embodiment of the invention in which racks used in connection with shipping of certain larger goods are returned from a customer. For example, these racks would be returned pursuant to a “return” request as described above with respect to FIG. 1. For example, racks are returned to the supplier after delivery of a particular shipment and the returned racks are either used “as is” for subsequent shipping, repaired and then reused for subsequent shipping, or scrapped.

Referring to FIG. 6, after truck 31 picks up a rack from supplier's facility, i.e., pursuant to a “return” request made via the FTP connection or the secure web server, the rack is delivered to a staging area 101 via the receiving department 100 in supplier's facility or warehouse. An initial assessment 102 is made with respect to the rack as to whether or not the rack needs any repair or whether it is viable for further immediate use in its present condition, e.g., “as is”. If the initial assessment results in a determination that the rack is “good”, that is, it is viable in its present condition, the rack is relabeled 103, e.g., with a new label similar to the label 33b discussed above with respect to FIGS. 2 and 4. The new label, however, contains data for a new shipment to be shipped on or in the rack. In addition to the rack being relabeled, if any parts of the rack are missing, or otherwise need to be added to the rack, these parts are added and the rack is again available to be used for shipping via the shipping department 104.

If, on the other hand, the initial assessment of the rack results in a determination that the rack is “bad” or, in other words, needs repair, a more detailed assessment 105 is performed. If, as a result of the more detailed assessment, the rack is determined to be “good” and no repair is needed, the rack is relabeled and any missing parts are added 103. The rack is then reused as discussed above.

If the detailed assessment of the rack results in a determination that repairs are, in fact, necessary, a cost associated with the repair is determined 106. If the cost of the repair is below a lower threshold, for example $30, the repairs are made 107 and the rack is relabeled and reused 103 as discussed previously. If the cost of the repair is between the lower threshold and an upper threshold, for example, $70, a report for the customer is generated 108 and the rack is repaired 107 and then relabeled 103 and reused, as discussed above. Optionally, after the report is generated for the customer 108, approval for the repair work can be implemented via the website 109.

Finally, if the cost of the repair work exceeds the upper threshold, website approval for the repair 110 is required. In accordance with the website approval 110, three potential actions can be taken. First, it may be determined that the repair work should be performed regardless of the cost. In this case, the repair work is performed 107 and the rack is relabeled and reused as discussed above. Second, it may be determined that the repair should not be performed under any circumstances. Under this scenario the rack is scrapped 111. Last, it may be determined that the rack should be held in order for a customer visit to be conducted 112. For instance, the customer may wish to personally inspect the rack. Under these conditions, the customer may ultimately decide to scrap the rack 111 or it may decide to perform the needed repair work 107. If the repair work is performed, the rack is then relabeled 103 and reused as discussed above.

### Defense Optimized Tracking System

According to a specific embodiment of the present invention, a tracking system (known as DOTS Defense Optimized Tracking System™) is a customer driven, easily customizable system allowing the tracking and visibility of assets from preproduction to a fully assembled product, and may include at least one of shipping, receiving, or environment monitoring. The system also allows for importing, exporting and integration with other systems and software. In specific embodiments, all interfaces into the process, assets, tracking, and configuration of the system are accomplished through the web.

The system may include mobile and handheld components for at least one of (1) warehouse and production floor management or (2) logistics and transportation control. In specific embodiments, communications utilized by the mobile components include, but are not limited to, cellular GSM/CDMA, 802.11b/g as well as wired USB and Ethernet.

In specific embodiments, the handheld computers allow personnel to input assets (including any number of properties and pictures), track flow of processes or repair status, as well as ship and receive. This allows the system to know pin point locations of all assets. The system can be configured to imitate virtually any process, fit any environment, and receive data from multiple sources.

In specific embodiments, back end systems are replicated near real time, to multiple off site locations. Power may be backed up via battery and generator, and multiple Internet connections may allow for a quick failsafe should problems arise.

### I. Web Interface

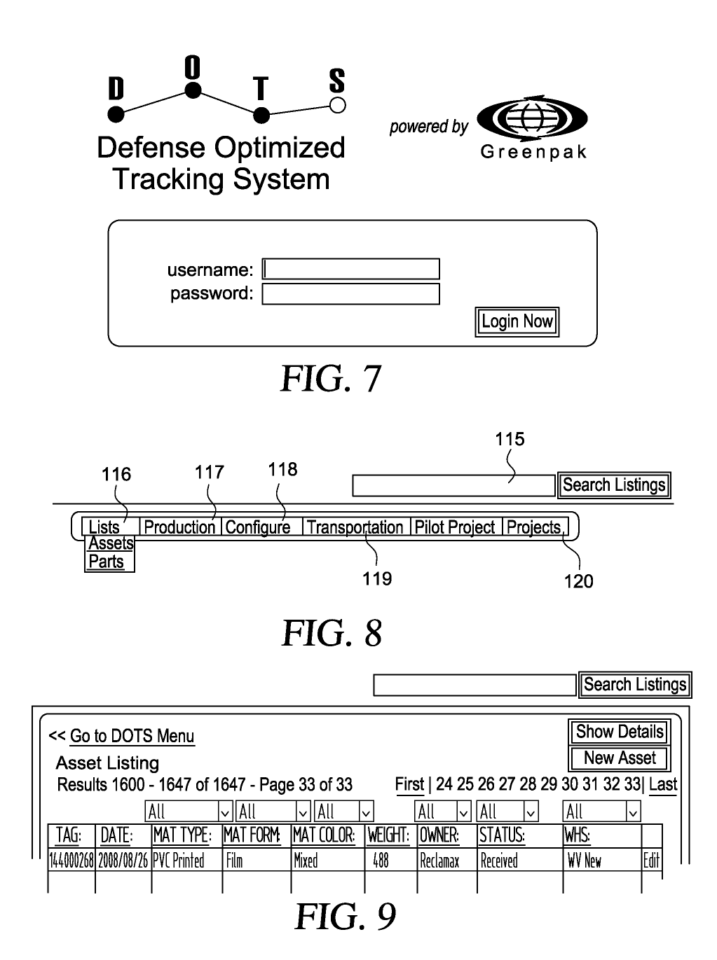

The system web interface and mobile or handheld component offer a secure login (e.g., using SSL encryption), as illustrated in FIG. 7. From the main menu of the web interface, as illustrated in FIG. 8, a user can choose to search 115, view a listing of assets or parts 120, production 125, system configuration 130, access a transportation interface 135, or projects 140.

### II. Asset Management

The system can manage any number of items including, but not limited to, at least one of raw materials, assets, components, finished goods, or parts. An item is classified depending upon its use and/or situation. In specific embodiments, an asset may be a single item (e.g., a screw). When an asset is used (e.g., the screw is used in a motor), a new item (motor) comprises several components and may itself be another asset. For example, a parent asset may comprise several sub-components.

In specific embodiments, asset management can be achieved through at least one of a handheld computer, for example used by authorized floor personnel, or through the web interface by an authorized user. When an asset is received or created, the asset may be assigned an asset tag and added to the system. Pertinent information for the asset including, but not limited to, date received, pictures, part number, description, quantity, supplier, manufacturer, calibration, recalibration and expiration dates, if applicable, may be entered into the system as asset properties discussed below.

A. Asset List

An asset list may display a list of all assets along with pertinent asset properties. In specific embodiments, the system only allows access to assets a user has been authorized to view.

In specific embodiments, the web interface of an asset listing 145 may include at least one of the following functionalities, as illustrated in FIG. 9:
a) Search Feature;
b) Pagination;
c) Per user column settings (a user can specify what fields should be display on asset/part listings);
d) Per user Column/field filters;
e) Column/field sorting; or
f) Per user Column/field totals.

B. Asset Properties

Assets may be traceable by properties which are displayed when viewing an asset in the system web interface. General properties for an asset may include, but are not limited to, at least one of location; status; BOL; carrier; model number; or serial number. User-definable properties for an asset may include, but are not limited to, at least one of calibration date; expiration date; material type; quantity; description; weight; supplier; or SPEC number.

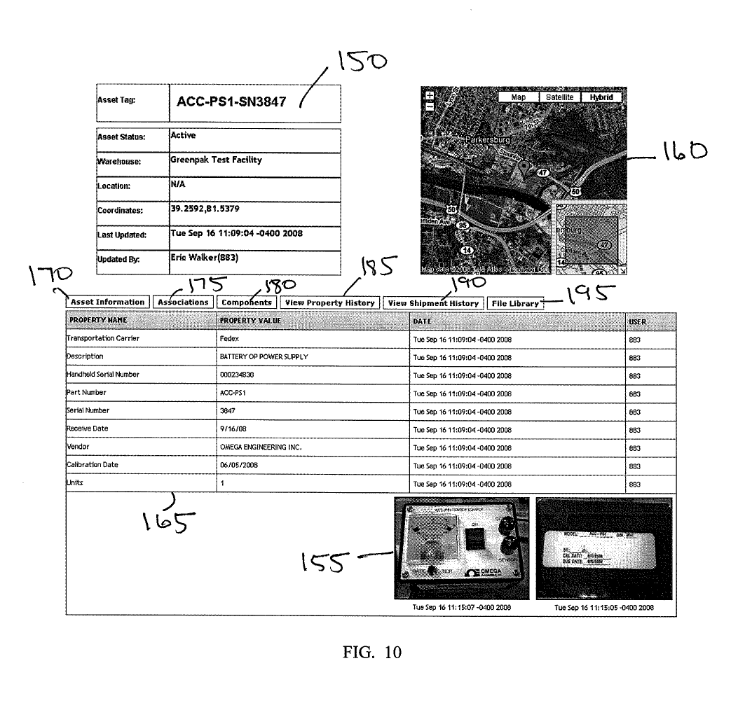

In specific embodiments, an asset in an asset listing may be selected and the resulting information may be displayed. FIG. 10 displays asset information, including at least one of asset tag 150, quantity, pictures 155, location 160, or properties 165. As illustrated in FIG. 10, an asset properties screen may have at least one of the following exemplary tabs: Asset Information 170; Associations 175; Components 180; View Property History 185; View Shipment History 190; File Library 195. Other tabs such as Action/Labor and Active Sensors are shown in other figures discussed below.

C. Asset Information

In specific embodiments, the asset information tab 170 displays pictures of an asset and its asset properties, as illustrated in FIG. 10. Asset properties may be added or modified using at least one of the web interface or a mobile interface.

D. Associations

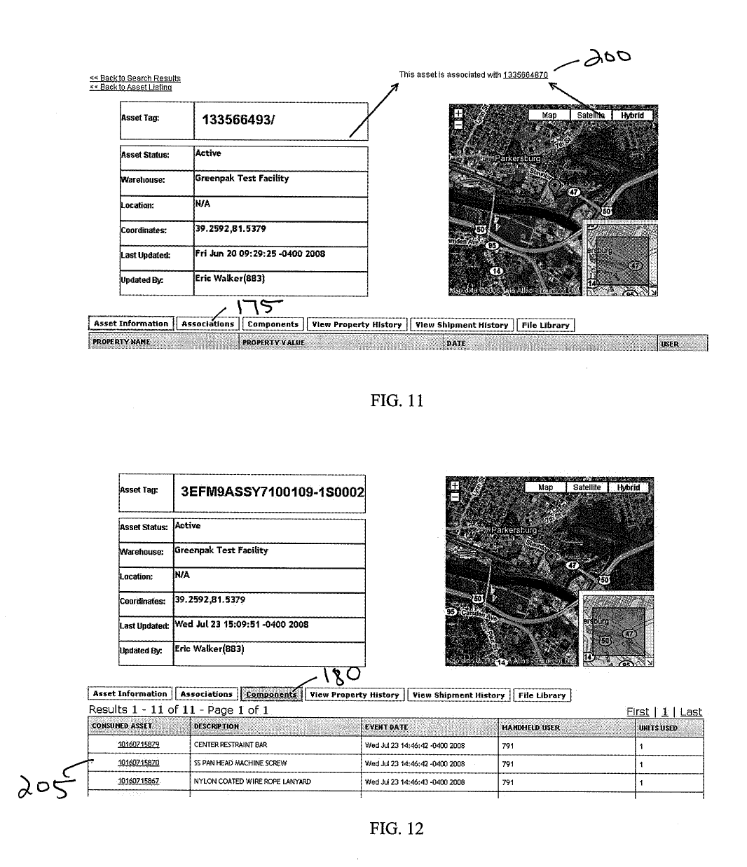

In specific embodiments, an associations tab 175 displays a list of assets associated or linked together, as illustrated in FIG. 11.

In specific embodiments, an asset may be associated with another asset, component, or finished good. For example, a bicycle may be associated with its major components: a frame, wheels, gears, and handle. When these individual components are put together to form a bicycle, they are associated and may be tracked by a primary asset (e.g., the frame). In other embodiments, an asset may be associated or linked with almost anything selected by an authorized user including, but not limited to, a report, project, warehouse, carrier, user, person, employee, piece of equipment, pallet, or the like.

A user can click on any of the associated assets to view its information and properties. If a user is viewing an asset that is associated with a primary asset, the system interface may provide a link to the primary asset 200 on the asset view screen.

E. Components

In specific embodiments, a finished goods inventory allows for tracing back through every component or asset of a finished good. Continuing with the bicycle example, a bicycle is made up of individual assets all of which may be given lot or serial numbers upon receipt. When an asset is used or consumed as a component of another asset or finished good, the initial asset is removed from inventory, and indicated as a component of the consuming asset or finished good. In the same way, the bicycle may be part of a larger item, such as a container.

FIG. 12 is a screenshot of the components tab 180. A user can drill down from a container or finished good to its components and to its consumed assets 205. This not only helps with inventory control, but it allows a history to be kept.

If certain components of a finished good are failing, a user can see if the components came from the same lot. This may help determine if that lot of components is defective. If it is determined that the lot is defective, a user can trace all finished goods that used the bad lot of components and take appropriate action to prevent future failure of finished goods manufactured from that lot of components. A user may know the manufacture, supplier, where and when each component and/or asset was purchased.

F. Action/Labor

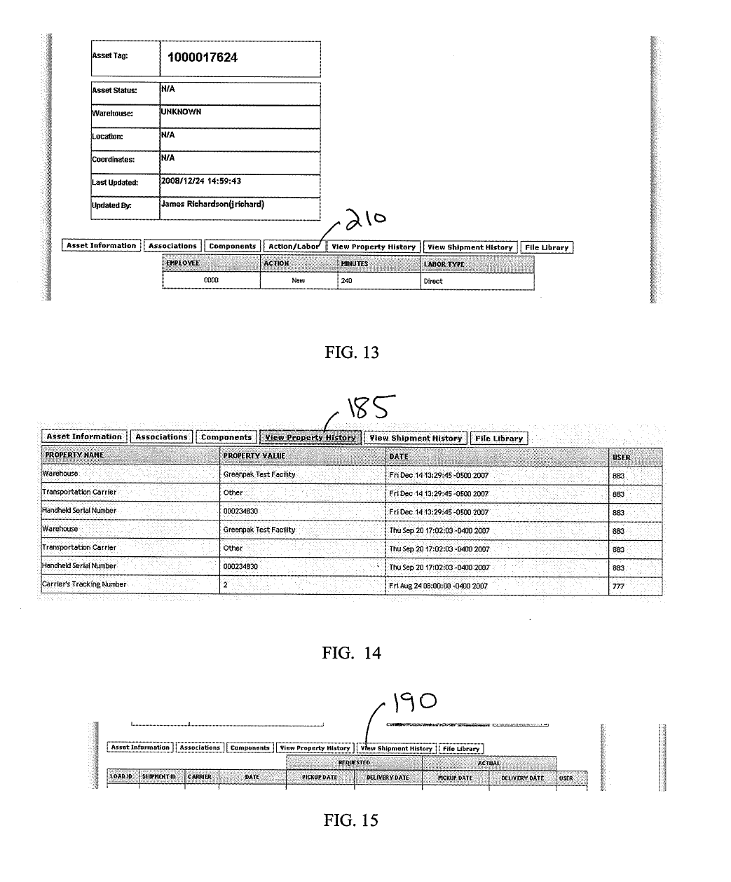

In specific embodiments, labor is traceable just like a finished good components. An Action/Labor tab 210 in an asset view screen as illustrated in FIG. 13 may show any specific production actions or labor that have been posted against or that occurred during the creation of an asset. The action/labor may include, but are not limited to, at least one of name of employee, action taken or performed, time, or type of labor.

G. View Property History

The system tracks changes made to an asset and its properties. Changes may be made by at least one of a mobile or handheld computer or by the web interface. When the properties of an asset are changed, they are reflected under the asset information tab 170. A history of the previous properties, and, for example, who added, or changed them may be stored within the system, are displayed via the property history tab 185. FIG. 14 is a screenshot of the View Property History tab.

H. View Shipment History

When an item is shipped, it may be automatically removed from inventory. In specific embodiments, the shipping method and BOL number may be updated. The view shipment history tab 190 may show any shipments and loads this asset was part of and, for example, at least one of pickup and delivery times, carrier, load ID, or the like, as illustrated in FIG. 15.

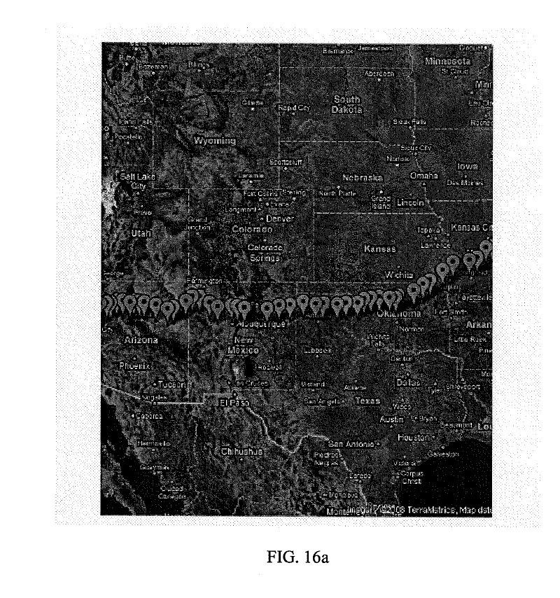

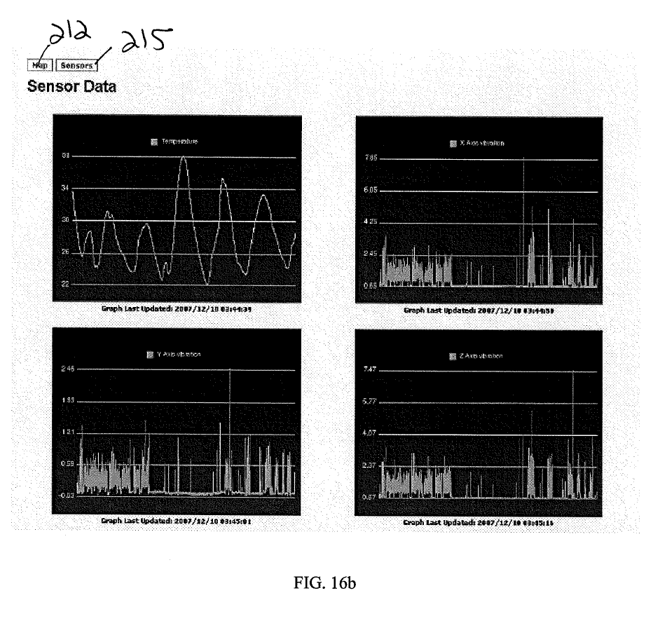

Clicking on a load ID may allow access to shipment details. In specific embodiments, (1) a Map tab 212 may allow access to a map showing the route traveled if available, as shown in FIG. 16a; and/or (2) a Sensor tab 215 may allow access to any sensor and health monitoring information used on an asset during shipment, as shown in FIG. 16b. The system advantageously allows tracking of assets even when shipped by different carriers.

I. Active Sensors and Health Monitoring

In specific embodiments, assets may be equipped with at least one sensor and a GPS device. Alternatively, or in addition, a carrier for an asset (e.g., a car, truck, trailer, train, plane, ship) may be equipped with at least one sensor and a GPS. Sensors may be associated with an asset during at least one of shipment or during testing. Sensors may include, but are not limited to, at least one of location, temperature, vibration, or humidity.

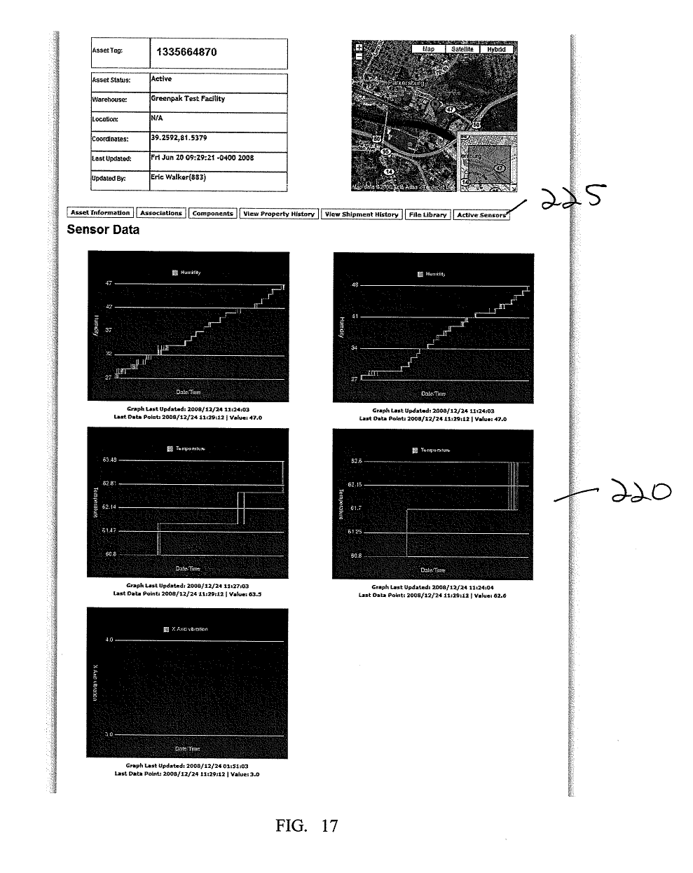

Once sensors are associated with at least one of an asset or carrier, the system imports sensor data (e.g., via GPS device) from the sensors and displays graphs 220 based on user parameters. The data may be displayed via an Active Sensors tab 225 in near real time, as illustrated in FIG. 17. In specific embodiments, the Active Sensors tab may only be available when an asset is currently being monitored.

An alarm can be setup in the system based on at least one threshold value. In specific embodiments, the system may send an e-mail or SMS/text message to a user (e.g. to a cellular telephone or personal digital assistant) based on the at least one threshold or trigger. The following are some non-limiting examples of alarms or alerts:

### EXAMPLE 1

There is a sensitive asset that a user would like to know when and who is searching for and/or viewing this asset. The system could alert the user that user X viewed (or performed a search on) this asset at Y time.

### EXAMPLE 2

An asset is temperature sensitive and must remain between 33° F. and 45° F. The system may send a message to the person currently in charge of that asset if the asset reaches 40° F. This way the person could determine the problem with the temperature control chamber before the asset reaches its maximum temperature. If it cannot be immediately repaired, the asset could be moved or protected in some way to keep it within the temperature range.

### EXAMPLE 3

An asset needs to be inspected if it feels g-forces in excess of 10G. The system can send a message to the appropriate person if and when the asset has exceeded the maximum force. The asset can then be flagged for inspection.

### EXAMPLE 4

A user has an asset that needs periodic maintenance or calibration. The system can inform then user at a specified amount of time before the calibration is due. The system may also send out a message when the asset has expired.

J. File Library

A file library may be used to attach pertinent information to an asset. Any type of file may be added to an asset using the file library including, but not limited to, at least one of test documents; videos; inspection documents; MSDS sheets; calibration certificates; certificates of conformance; reports; or logs.

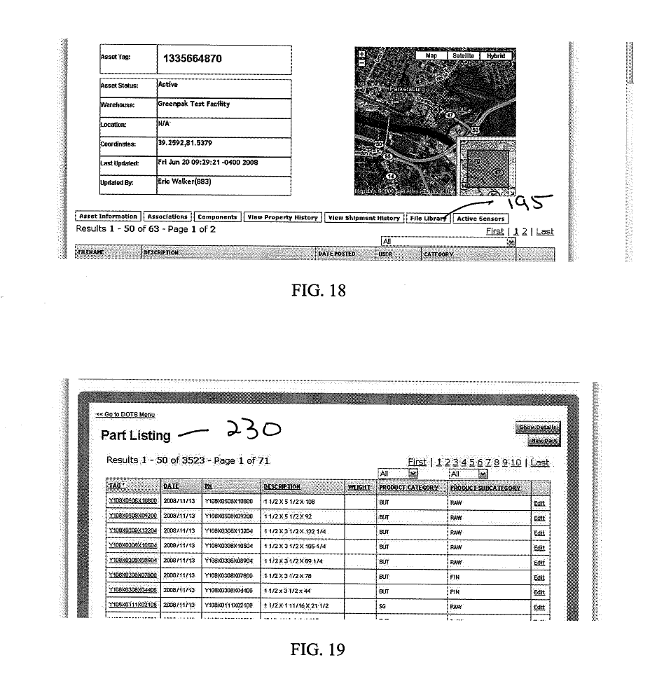

The file library tab 195, as illustrated in FIG. 10, displays the files that are attached to an asset. In specific embodiments, a user may be able to view at least one of the filename, description, date the file was added, or the user that added the file, as illustrated in FIG. 18. The file library tab also enables filtering by file category. In specific embodiments, clicking on a filename allows access to the file attachment.

II. Part Management

Part management is similar to asset management. A part is a non-tangible object that represents an asset or component. A part defines at least one of the time, materials, labor, vendor, make, model, size description, or other properties that make up an asset or component. A part is in essence a template or blueprint of an asset, component, or finished good. In specific embodiments, a part may comprise a standardized list of properties required to create a part representing an asset, component, or finished good. The standardized list of properties may comprise standardized labor and actions.

Through part management, the system knows what assets, components and labor are required to build a final good. In specific embodiments, when production occurs, the system may automatically post used components to a completed finished good and remove the used components from inventory. A user may be able to tell the direct and indirect cost(s) involved with each finished good or product.

A. Part List

As illustrated in FIG. 19, a Part Listing 230 displays a list of all parts along with pertinent part properties. In specific embodiments, the system only allows access to the parts belonging to the programs a user has been authorized to see.

B. Part Properties

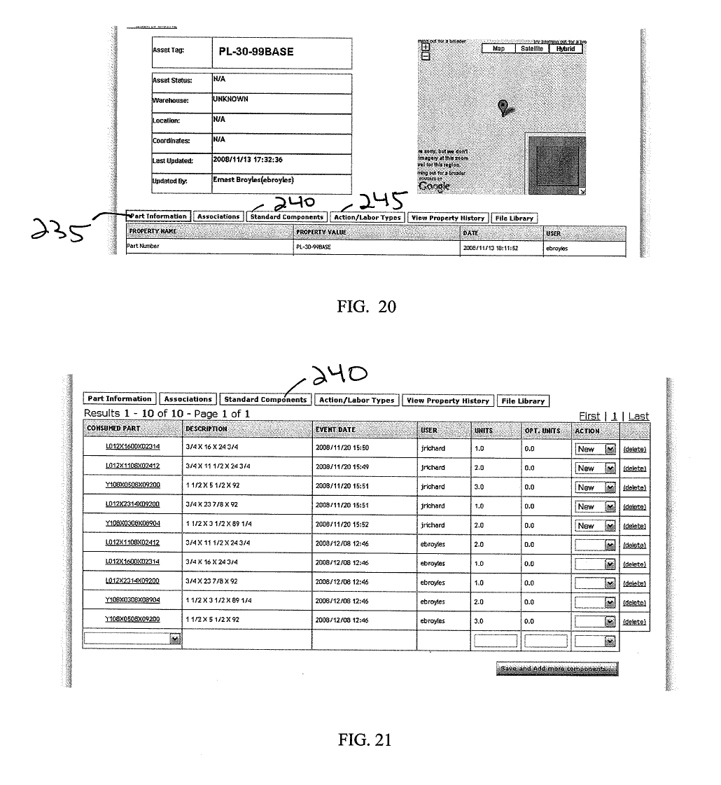

A Part Information and properties display 235 looks similar to an asset information and properties display. However, there are two tabs are different, as shown in FIG. 20: Action/Labor Types 240 (as opposed to Action/Labor) and Standard Components 245 (as opposed to Components).

C. Standard Components

The Standard Components tab 240 shows a list of assets (components) that are required to create a part, as illustrated in FIG. 21. Standard components are often referred to as the Bill of Material, BOM.

D. Action/Labor Types

The Action/Labor Types tab 245 shows any standard action(s) that can be taken on a part or asset including the labor involved with that action.

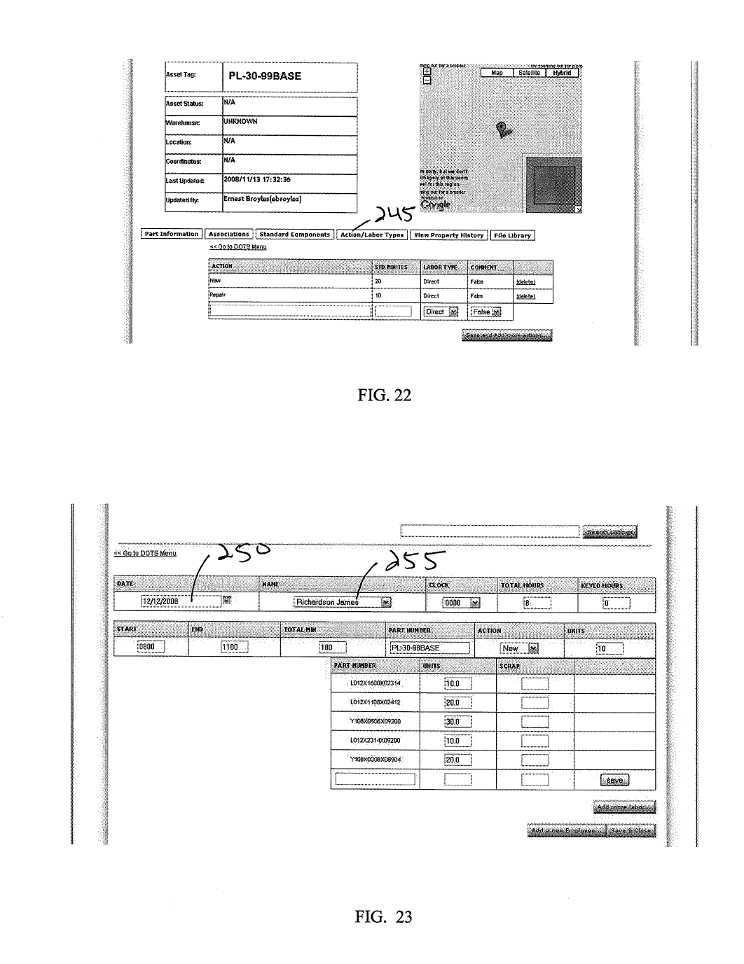

Standard Components may be associated with an Action/Labor Type. This is useful when a part has different actions that can occur. For example, one list of Standard Components is necessary when a new asset of this part is created. However, if a repair is made, not all of the components would be needed to complete the repair. Two actions in this example may be defined New and Repair. The components and labor on the Standard Components tab would be associated to the appropriate action type, as shown in FIG. 22. In a specific embodiment, the system may show that it takes a standard set of components and standard labor actions to make an particular item.

### III. Production

In specific embodiments, the production tab 125 of the system interface (FIG. 8) displays a Production screen, as shown in FIG. 23, which allows for entry of production/work. The entry may be done through at least one of a handheld or mobile computer or the web interface. Production may be entered by date 250, for example, daily, weekly, monthly, or the like. All work by an employee 255 may be entered into the system and will appear for each asset on its action/labor screens. By combining the materials and the labor involved, a full picture of the costs involved in creating the asset can be seen.

### IV. Projects

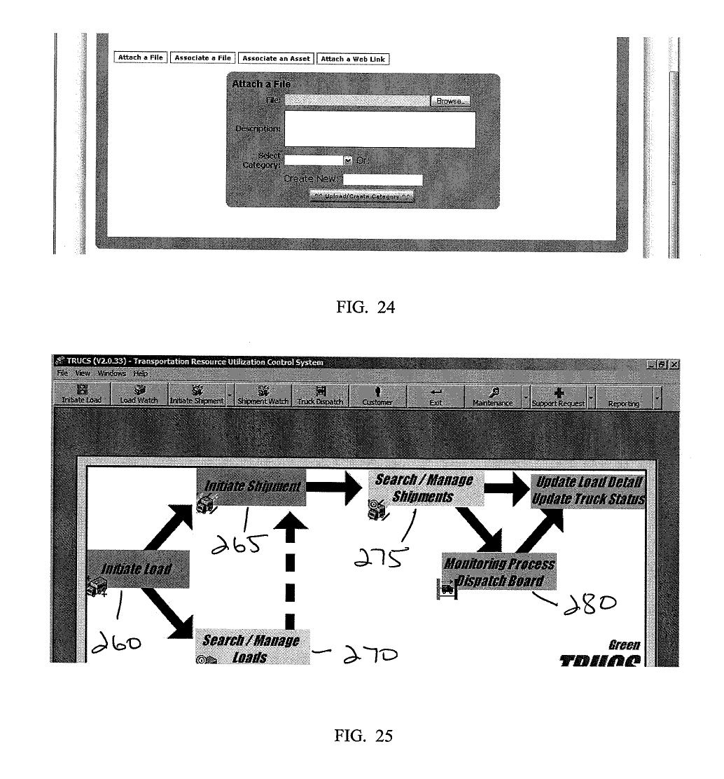

In specific embodiments, the projects tab 140 of the system interface (FIG. 8) displays a projects menu that allows a user to create an area that links assets and files associated with a particular project into one easily accessible hub. This reduces time searching through thousand of files and assets to find project specific materials. The system only allows access to the assets within the project the user has been authorized to see. Through the projects tab, a user is able to add new files, links to websites, and links to any files and assets currently in the system, as illustrated in FIG. 24.

### V. Transportation

A. Desktop

In a specific embodiment, the system enables Transportation Management and Dispatch through a desktop extension (TRUCS, Transportation Resource Utilization and Control System). Transportation ties at least one of customer service, load/shipment building, dispatching, driver management or billing into one integrated solution.

The main Transportation window has links to all main functions, including at least one of Initiate Load 260, Initiate Shipment 265, Search/Manage Loads 270, Search/Manage Shipments 275, and the Dispatch Board 280, as illustrated in FIG. 25.

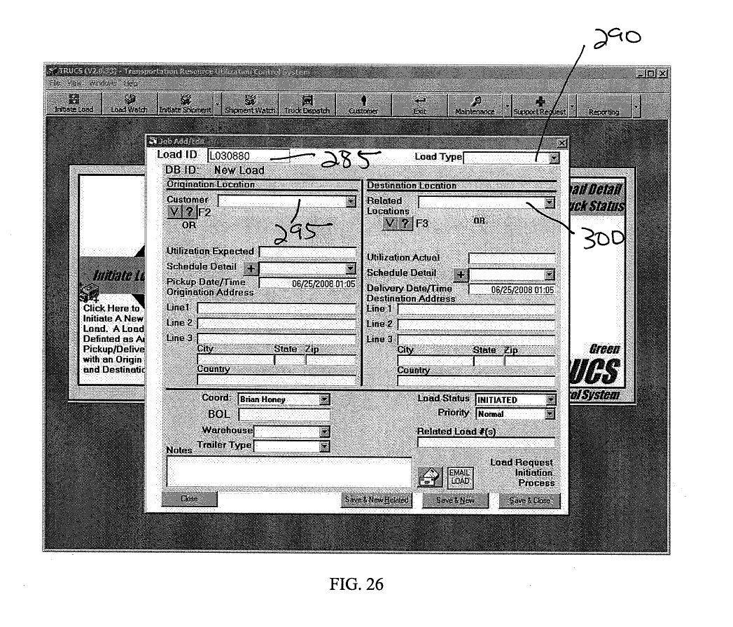

As illustrated in FIG. 26, in specific embodiments, a load initiation screen or window may be used by customer service when scheduling a pickup or delivery per a customer request. A Load ID 285 is automatically generated for a pickup or delivery request. A Load Type 290 is selected. Fields on the load initiation screen include sections for Origination Location 295 and Destination Location 300 for the Load, including at least one of scheduled dates and times, locations, and other load details. A Support Request tab is a feedback tool that allows users to report problems. A Maintenance tab is for configuration management and helps manage carriers, users, messaging, and the like.

In specific embodiments, the fields may comprise drop down menus with either pre-configured or historical data as in the customer drop down. Existing customers may be searched using one or more criteria. In addition, a user may add new customers by clicking an Add button.

Information selected in the search tool may be loaded into the Origination Location 295 area. Other data may be input or collected, such as the expected utilization, the schedule detail, and pickup date/time information.

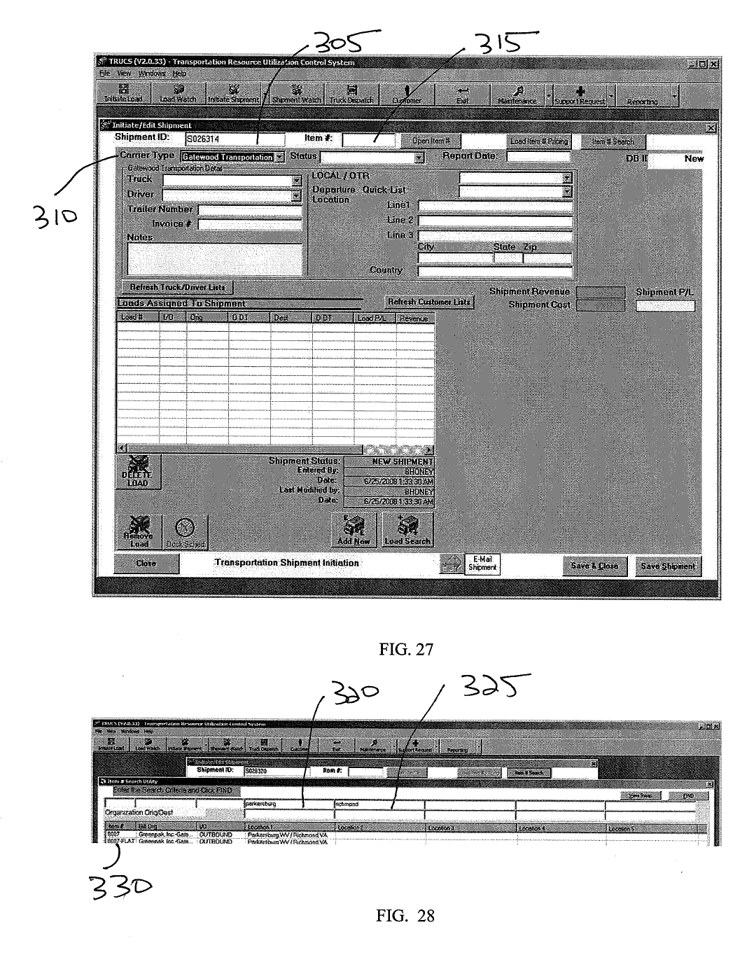

Once loads have been entered, transportation will initiate shipments containing the created loads. In specific embodiments, a shipment ID 305 is automatically assigned. A carrier type 310 is selected, as illustrated in FIG. 27.

In specific embodiments, a user adds loads to build a shipment, as illustrated in FIG. 27. Typical or reoccurring shipments may already be setup as an “Item Number” 315 that defines the locations, pricing and detail information for a given set of loads. For other loads and shipments, a user may either search for loads that have been created by others, or build them via this screen.

As illustrated in the Item Number Lookup screen of FIG. 28, a user may enter search criteria for Origins 320 and Destinations 325, and click an Item Number row 330. In specific embodiments, the locations and stops included may appear, for example, in a colored area (e.g., yellow) at a bottom of the screen.

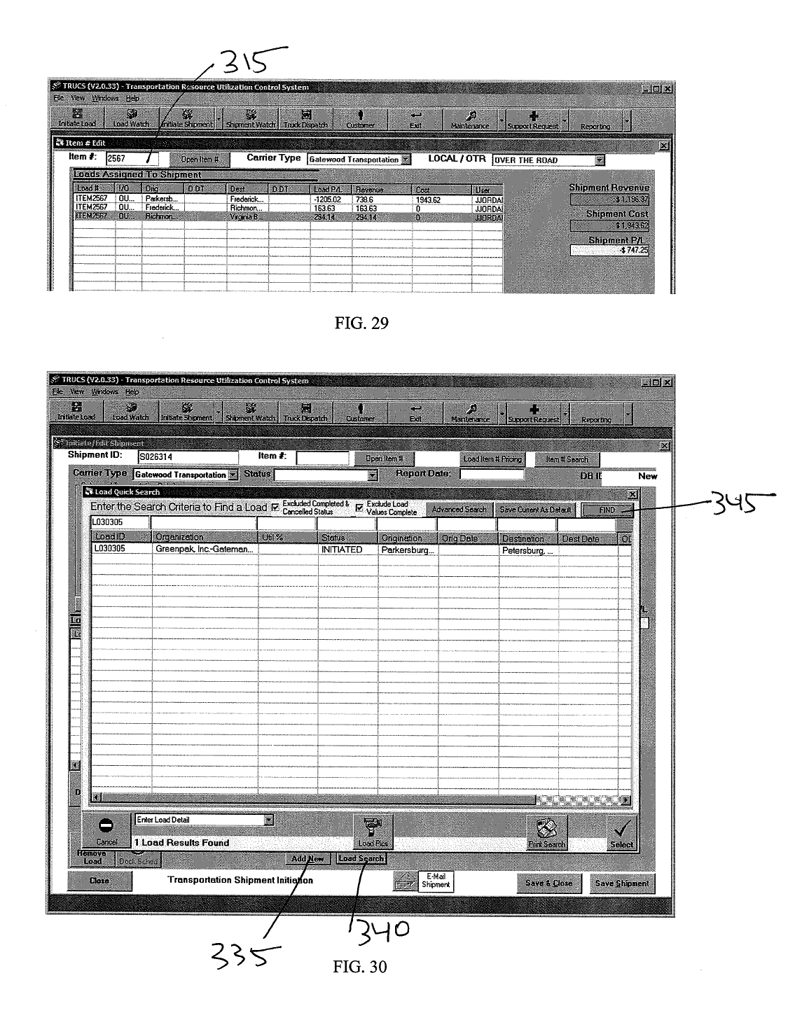

On an Item Number Search, a user may click an Edit/View button, to open the Item Number Edit or Maintenance screen, as illustrated in FIG. 29. The user may view the details of the Item Number 315 and edit the individual Loads within. A predefined item number may auto-load the Load information for the stops defined in that Item Number.

An Initiate Shipment screen is illustrated in FIG. 30. A user may click either the Add New 335 or Load Search 340 buttons at the bottom middle of the Shipment window. The user may search for Loads by the Load ID number or any other criteria listed. The user may type a search string, then click Find 345 at upper right. The user may select a row, and then click the Select button at lower right. This adds the Load information to the Initiate Shipment screen.

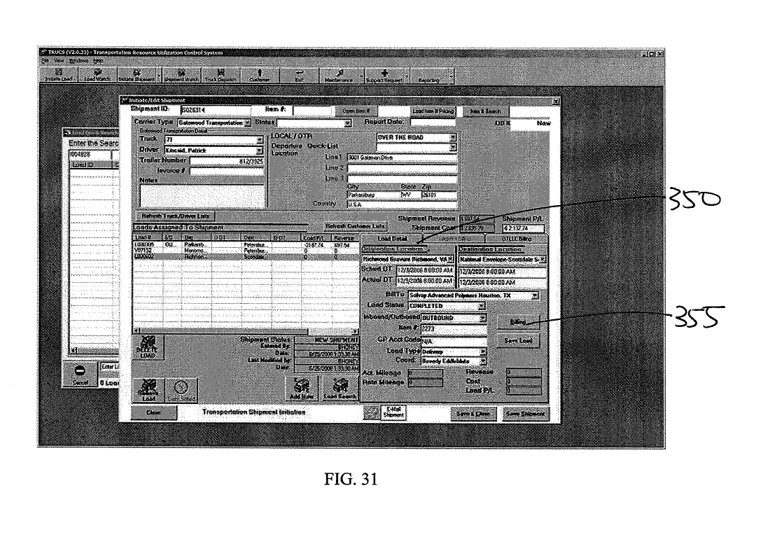

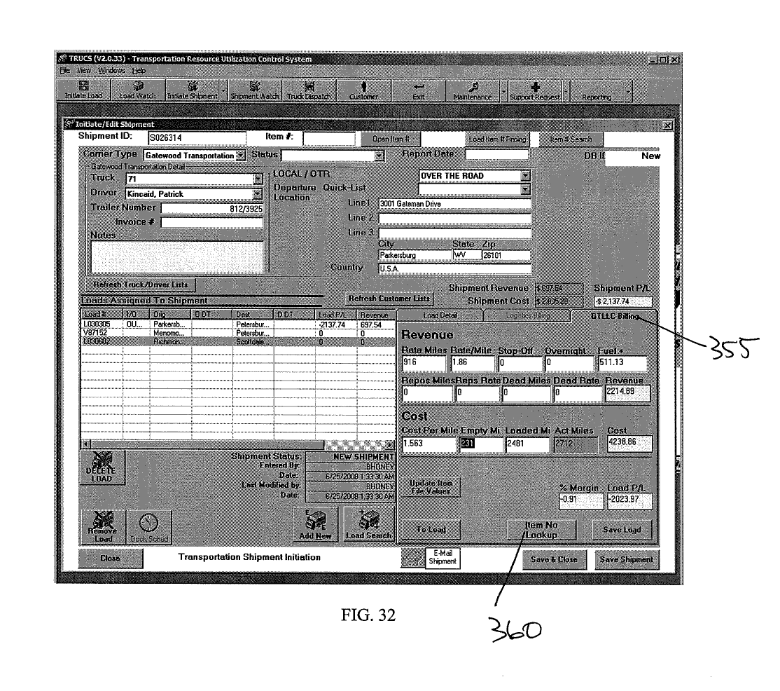

As Loads are added to the Shipment, details 350 for the shipment are entered, as illustrated in FIG. 31. In specific embodiments, a user may enter Billing Information for each Load in the area to the right on the Billing tab 355. The user may click the Item Number Lookup button 360 to auto-load Cost and Revenue information for various Loads, as illustrated in FIG. 32.

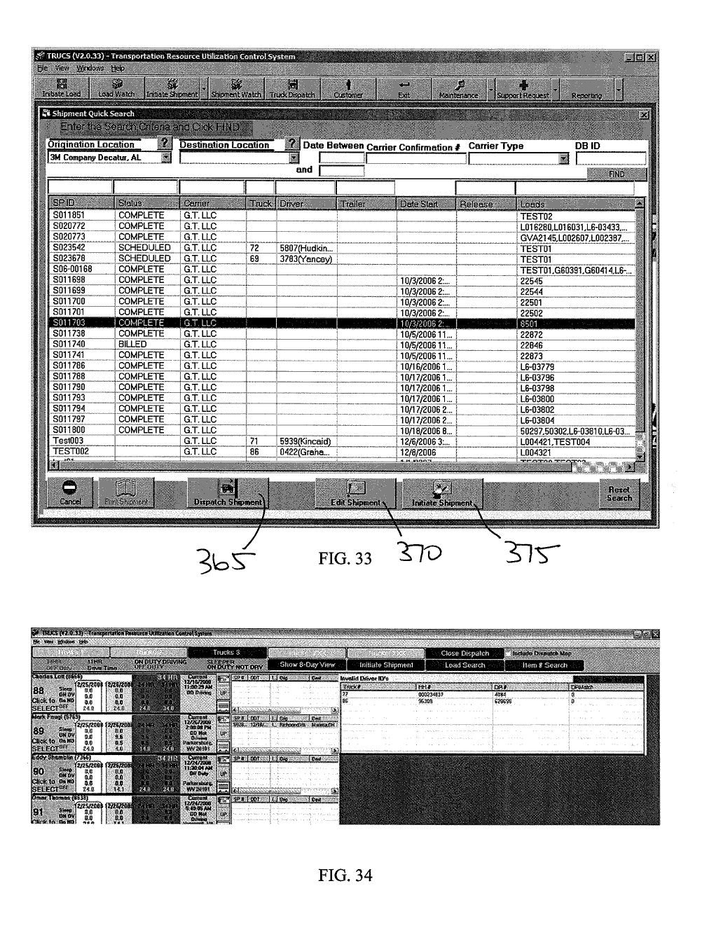

From the main transportation window (FIG. 25), a user may select Search/Manage shipments 275. The user enters one or more search criteria, and clicks Find. A user may then click Dispatch Shipment 365, Edit Shipment 370 or Initiate Shipment 375 along the bottom of this window, as illustrated in FIG. 33.

In specific embodiments, a dispatch board or interface gives transportation dispatch a full overview of the carriers and the loads that have been assigned, as illustrated in FIG. 34. The dispatch board tracks carrier times (e.g., drive times) to give dispatch a better handle of how long drivers have been on duty and when they will need a restart and be unavailable.

B. Web Interface

A carrier may be equipped with at least one of a handheld computer and an embedded computer. The embedded computer collects and distributes all information to and/or from a GPS device, carrier, handheld, and any environmental sensors. In specific embodiments, the handheld enables a driver to relay vehicle status, pictures, scanned assets or other information to transportation dispatch.

The system takes advantage of these features through the Transportation tab 135 of the web interface, as illustrated in FIG. 8. In specific embodiments, the web interface of FIG. 8 encompasses all the features of the Transportation desktop discussed above.

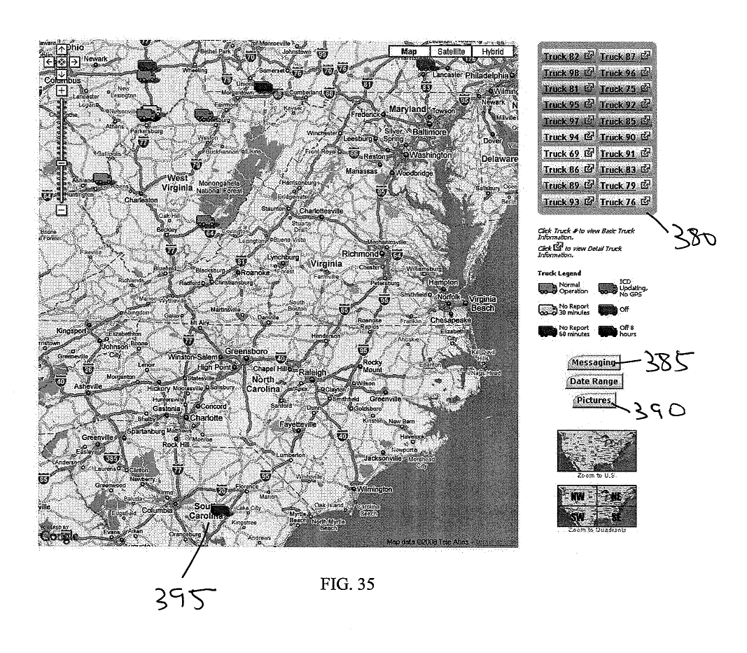

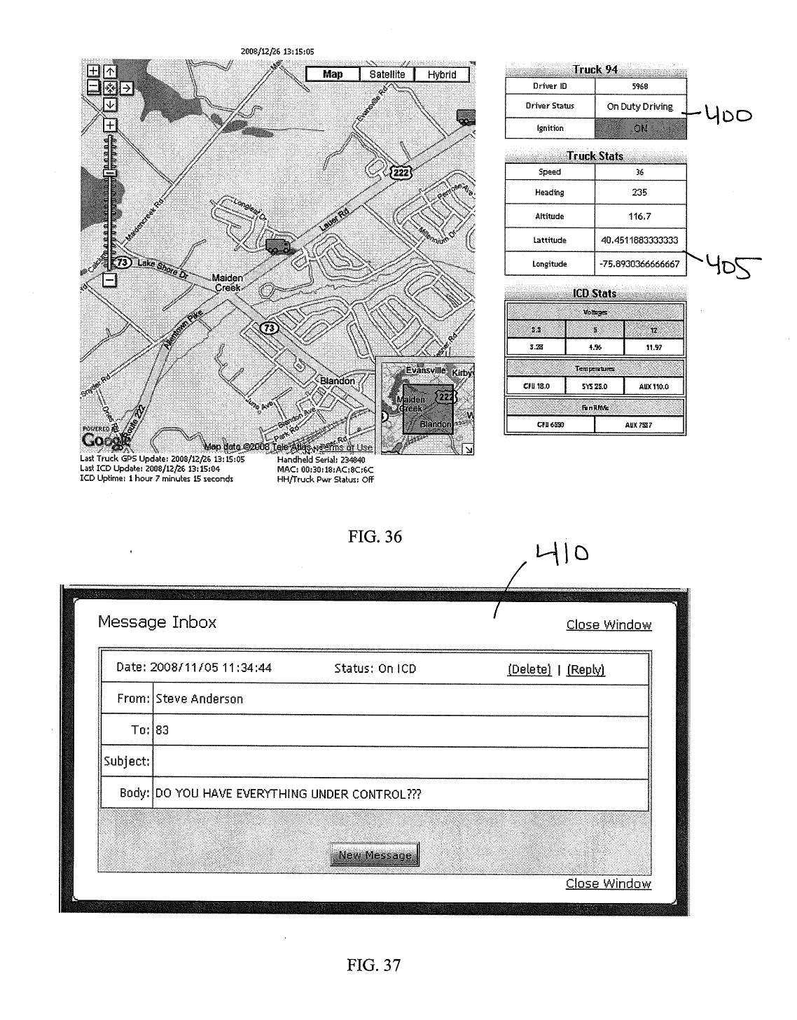

The web interface allows the near real time display and tracking of all carriers 380 via a Transportation Interface. From the web interface, transportation can interact with the drivers 385, review position/delivery history, view pictures 390 that drivers have posted via the handheld, view location on a status map 395, view carrier identifier 400, and view carrier statistics 405, and as illustrated in FIGS. 35-36.

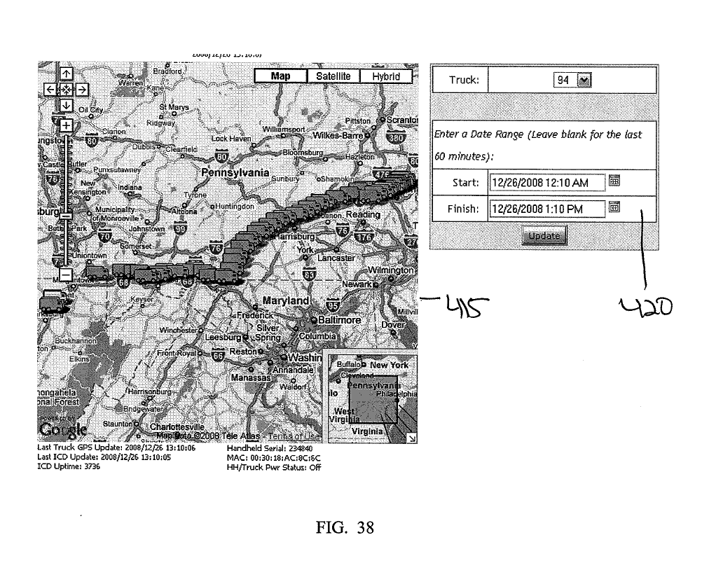

In specific embodiments, from a Messaging Interface 410, transportation dispatch can send messages to or receive messages from the carriers or drivers via a handheld computer, as illustrated in FIG. 37. A tracking interface allows dispatch to review a route history 415 that a carrier took for any range of dates and times 420, as illustrated in FIG. 38.

### VI. Mobile or Handheld Component

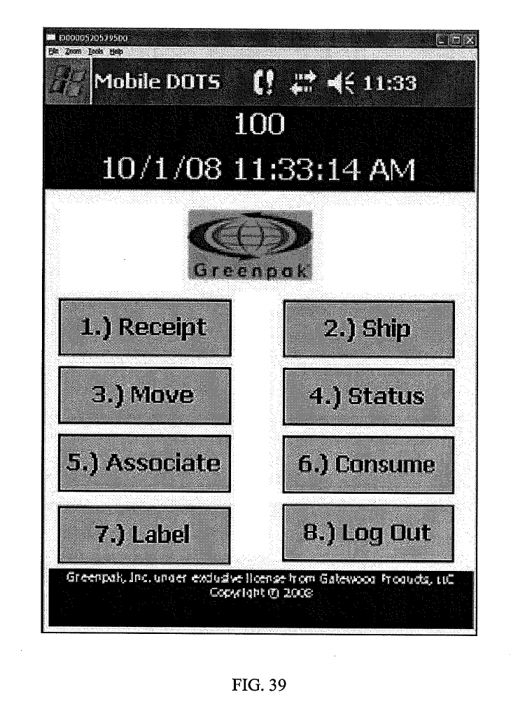

FIG. 39 shows a display of the handheld main menu. From the main menu of the handheld, a user has the options to receive, ship, move, view status, associate, consume, log out, or create and print labels.

A. Receipt/Ship

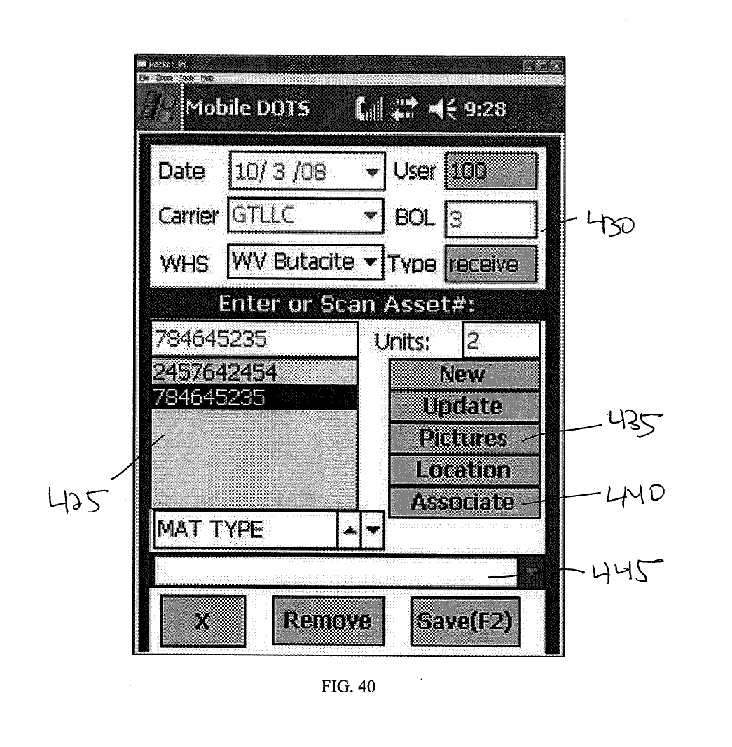

As illustrated in FIG. 40, the receipt and ship functions on the handheld are identical. In specific embodiments, the handheld allows for entering of multiple barcodes 425 both via an on board barcode reader or through manual input. Information such as Date, Carrier, BOL, Warehouse and units (or quantity), may be displayed at the top 430 of the receipt or ship screen.

As illustrated, buttons 435 may be provided for taking pictures, for example, via an on board camera or digital camera, and for snapping a GPS location via an on board GPS or an external Bluetooth GPS device. A button 440 is also provided for associating items at the time of receipt.

A bottom of the window 445 is for inputting any other properties necessary for the items being received or shipped. These properties might be Material Types, Calibration Dates, Part Numbers, Serial Numbers and any other properties configured in the system.

B. Move

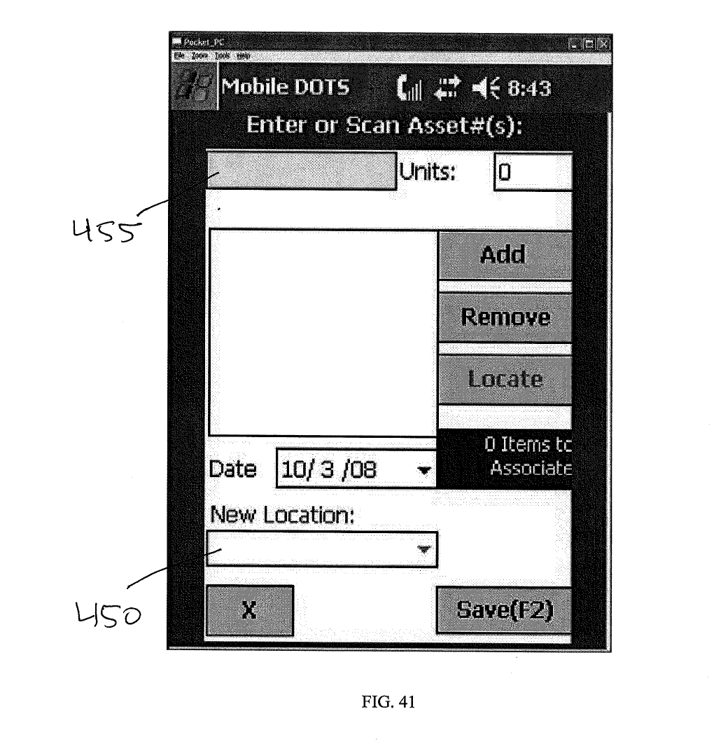

As illustrated in FIG. 41, the move function allows a user to relocate items within a defined space, for example, a building, warehouse, or other large enclosed space. Locations 450 may be completely customizable from using room numbers in an office building to being defined as grids in a warehouse environment. The units 455 (or quantity) that are being moved may be entered.

C. Status

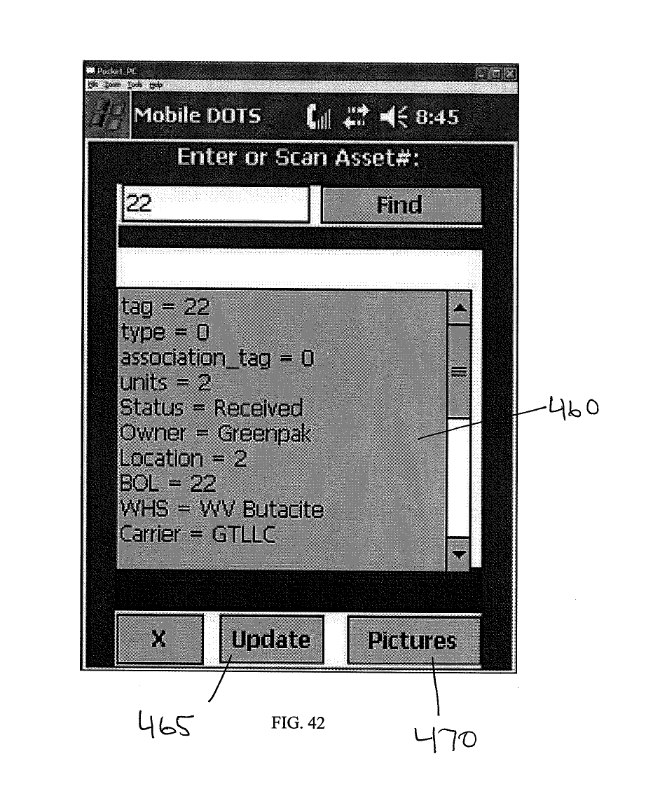

As illustrated in FIG. 42, the status function allows an operator to scan a bar code, or manually enter an asset tag and get access to all the information and properties 460 available in the system on the asset. The status function also allows the operator to update 465 any properties on the asset or take additional pictures 470.

D. Associate

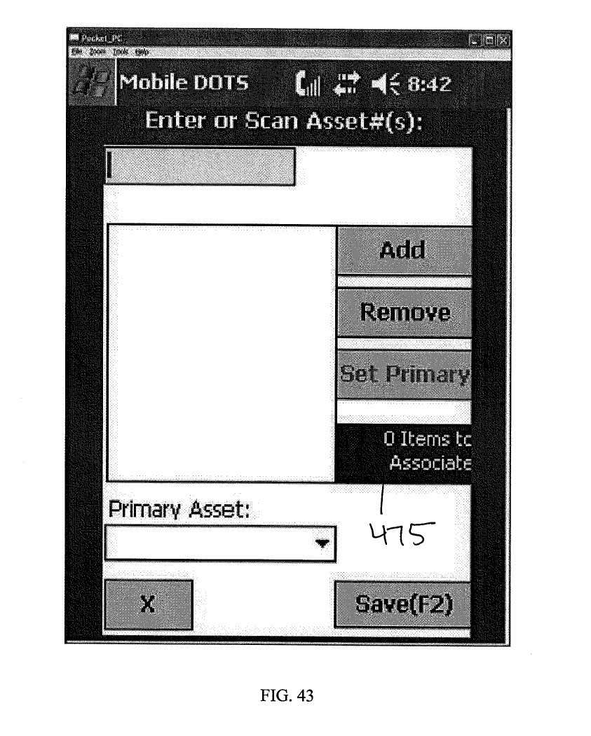

The associate function allows the operator to associate multiple assets together 475, as illustrated in FIG. 43.

E. Consume

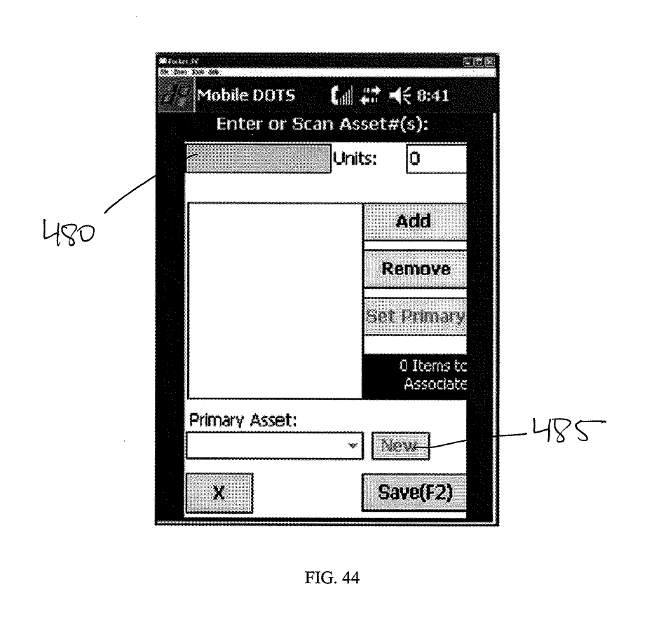

The consumption (or production) feature allows an operator to post consumed items against a finished good. The operator scans consumed items entering the quantity used 480 and then enters or scans the finished good. There is also a button 485 for creating a new asset, if a new asset will be created by consuming the items (FIG. 44).

### VII. Integration

The system can be integrated to communicate with any number of software programs and devices. It can be used as a stand alone system, or integrated as middleware to allow for communication between programs that could not otherwise communicate. In specific embodiments, the system may take input from multiple devices and systems, and then export the data in a format the other program(s) could accept. This allows for transparent data flow between systems. Forms of input may include wireless handhelds, environmental sensors, GPS tracking and logistical information.

Computer program elements of the invention may be embodied in hardware and software. The invention may take the form of a computer program product, which can be embodied by a computer-readable storage medium having computer-usable or computer-readable program instructions, “code” or a “computer program” embodied in the medium for use by or in connection with an instruction execution system. A computer-readable storage medium may be any medium that can contain, store, and communicate the program for use by or in connection with the instruction execution system, apparatus, or device. The computer-usable or computer-readable storage medium may be, for example but not limited to, an electronic, magnetic, optical, electromagnetic, infrared, or semiconductor system, apparatus, and device.

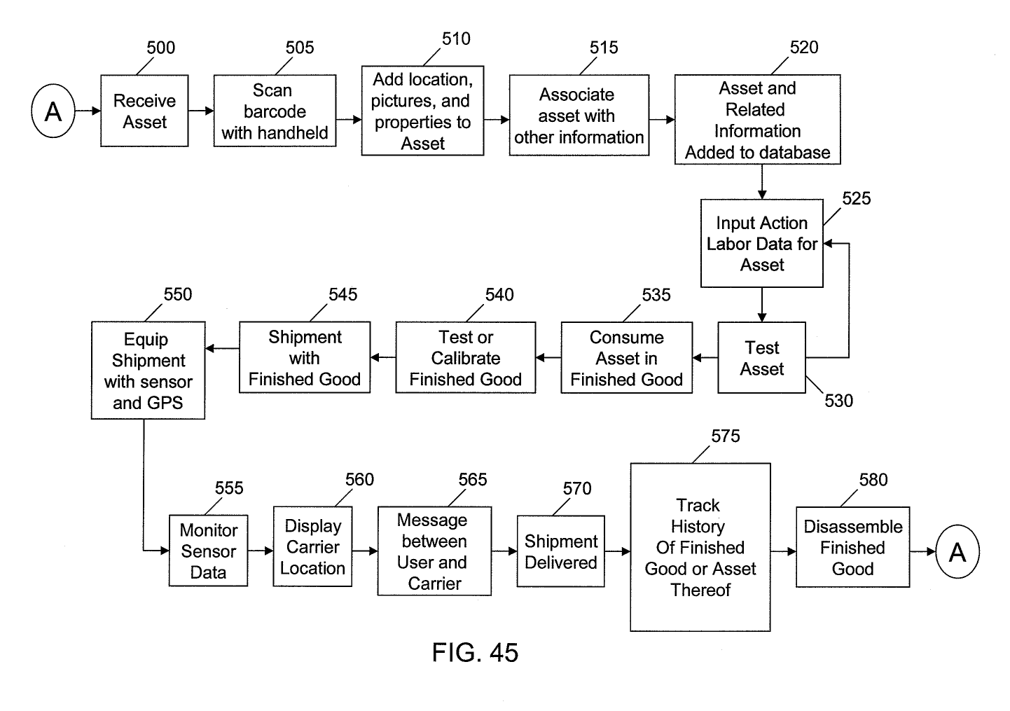

FIG. 45 is a flowchart of an exemplary embodiment for method of the present invention for tracking an asset. An asset is received into the system 500, for example, by floor personnel. At least one barcode of the asset is scanned 505 and at least one of properties, location, or pictures are added to the asset 510 via a handheld computer. The asset is linked or associated with at least one of other assets, components, goods, projects, people, or carriers 515. The information from the handheld is added to the system database 520.

Labor and production data are added to the system database 525. A test or calibration may be performed to determine whether the asset is satisfactory 530. If the asset passes the test or calibration it may then be consumed as a component in a finished good 535. If the asset fails the test or calibration, addition action or labor is performed on the asset. The finished good may also be tested or calibrated 540. The finished good becomes part of a shipment 545. The carrier of the shipment and/or the asset is equipped with at least one sensor and a GPS 550. Sensor data is monitored 555 and location is displayed on a status map 560 in the system web interface. Messaging may be conducted between carrier and user of the system 565. The shipment is delivered 570. The shipment history and/or property history of the finished good or any asset thereof is tracked 575. The finished good may be disassembled 580 and the cycle repeated.

According to an embodiment of the present invention for tracking an asset, at least one asset may be added to a computer system having a web-accessible graphical user interface. Properties for the at least one asset are added via at least one of a handheld computer or the graphical user interface. A searchable asset list is displayed in the graphical user interface, along with the quantity of each asset, location of each asset, properties of each asset, and at least one picture of each asset.

A plurality of assets may be used or consumed to make a finished good. According to the present invention a history (e.g., property history, shipment history, production and labor history) of at least one asset used to make the finished good may be traced. Thus, assets and/or components may be traced and tracked during one or more lifecycles. A finished good may be disassembled into a plurality of assets. At least one of the assets may be used to form a new finished good. The history of the at least one asset used to make the new finished good may be traced or tracked through both finished goods. For example, a circuit board asset may be used as a component in a computer. The computer may be disassembled and then a new computer with different components or an entirely new asset using the circuit board may be made. With the present invention, all assets, parts, and pieces may be tracked and information regarding each asset may be viewed.

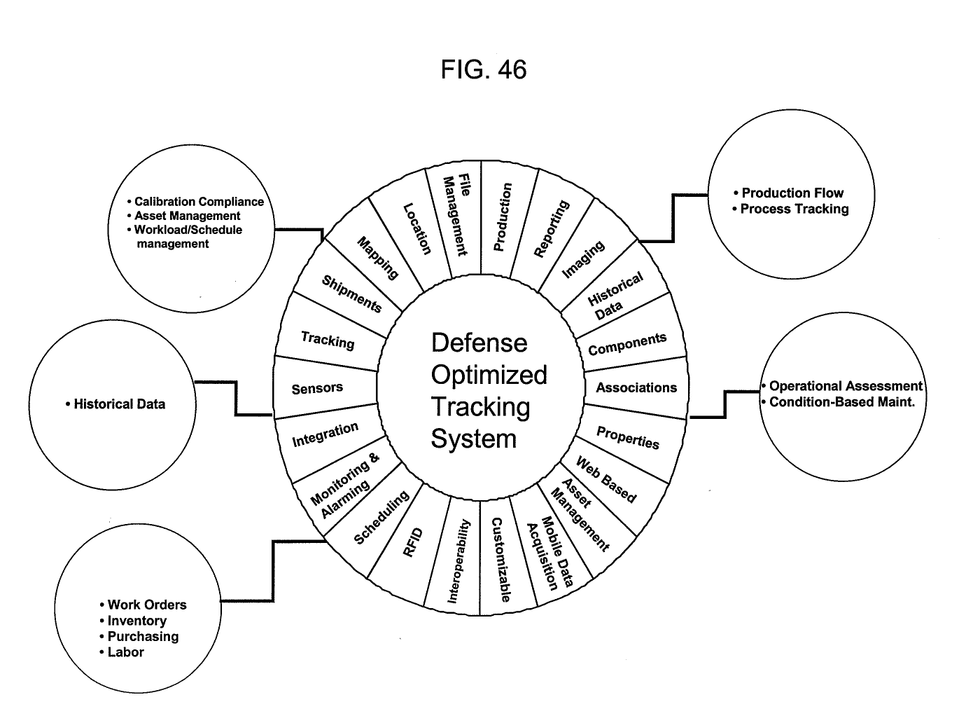

FIG. 46 is a schematic diagram of the exemplary functionalities of the system according to an embodiment of the present invention.

While various aspects of the present invention have been particularly shown and described with reference to the exemplary, non-limiting, embodiments above, it will be understood by those skilled in the art that various additional aspects and embodiments may be contemplated without departing from the spirit and scope of the present invention.

Other aspects, objects and advantages of the present invention can be obtained from a study of the drawings, the disclosure and the appended claims.

What is claimed is:

1. A method for tracking an asset, comprising:
adding at least one asset to a computer system having a web-accessible graphical user interface;
adding properties to the at least one asset in the computer system via a mobile or handheld computer; and
displaying a searchable asset list in the graphical user interface, along with the quantity of each asset, location of each asset, properties of each asset, and at least one picture of each asset.

2. A method according to claim 1, further comprising associating the at least one asset with at least one of a report, project, warehouse, carrier, user, employee, equipment, container, or pallet via at least one of the handheld computer or graphical user interface.

3. A method according to claim 1, further comprising associating the at least one asset with at least one other asset and providing a link to a primary asset.

4. A method according to claim 1, further comprising adding a production action or labor for the at least one asset.

5. A method according to claim 1, wherein the production action or labor comprises at least one of employee name, action performed, time, or type of labor.

6. A method according to claim 1, further comprising:
using a plurality of assets to make a finished good; and
tracing a history of at least one asset used to make the finished good.

7. A method according to claim 6, comprising tracing a property history of at least one asset, thereby identifying at least one of the manufacturer, supplier, or purchaser of the at least one asset.

8. A method according to claim 6, comprising tracing a history of production actions or labor for at least one asset.

9. A method according to claim 6, further comprising:
disassembling the finished good into a plurality of assets;
adding properties for the plurality of assets in the computer system via at least one of the mobile computer or the graphical user interface;
reusing at least one asset of the plurality of assets to make a new finished good; and
tracing the history of the at least one asset used to make the new finished good.

10. A method according to claim 1, further comprising;
shipping the at least one asset; and
equipping at least one of a carrier or the at least one asset with at least one sensor and a GPS device;
displaying data from the at least one sensor in the graphical user interface; and
displaying the route traveled by the carrier on a map in the graphical user interface.

11. A method according to claim 1, further comprising:
setting up an alarm based on a threshold value for the at least one asset; and
sending an e-mail or text message to a user when the threshold value is triggered.

12. A method according to claim 11, wherein the alarm is based on a name of a user accessing or viewing the at least one asset.

13. A method according to claim 1, further comprising creating a standardized list of properties required to create a part representing an asset, component, or finished good.

14. A method according to claim 13, wherein the standardized list of properties comprises standardized labor and actions.

15. A method according to claim 1, further comprising:
initiating at least one of receiving and shipping of at least one asset via the handheld computer;
taking pictures of the at least one asset with the handheld computer; and
taking a global positioning satellite system position via the handheld computer.

16. A method according to claim 1, further comprising exporting data for the at least one asset from the computer system to another computer system.

17. A method for tracking an asset, comprising:
entering a plurality of assets into a networked computer system having a web-accessible graphical user interface;
displaying a location, properties, and a digital photograph of the each asset in the web-accessible graphic user interface;
preparing a finished good comprising a plurality of assets;
shipping the finished good via a carrier equipped with at least on sensor and a global positioning satellite device;
transmitting data from the at least one sensor and the global positioning satellite device to the networked computer system;
displaying data from the at least one sensor; and
displaying the location of the carrier on a map.

18. A method according to claim 17, further comprising a user of the networked computer system sending a message to the carrier.

19. A tracking system, comprising:
a networked computer system comprising at least one computer providing a web-accessible graphical user interface;
at least on sensor;
a global positioning device;
a mobile or handheld computer operable to enter information into the computer system and receive information from the computer system, said mobile or handheld computer comprising a digital camera and a barcode reader.

20. A computer program product for tacking an asset, comprising a computer readable storage medium having computer readable code that when executed causes the computer to:
add at least one asset to a computer system having a web-accessible graphical user interface;
add properties to the at least one asset in the computer system via at least one of a mobile or handheld computer or the graphical user interface; and
display a searchable asset list in the graphical user interface, along with the quantity of each asset, location of each asset, and at least one picture of each asset.
